(19) United States
(12) Patent Application Publication
(10) Pub. No.: US 2023/0085827 A1
(43) Pub. Date: Mar. 23, 2023

(54) SINGLE-SHOT AUTOFOCUSING OF MICROSCOPY IMAGES USING DEEP LEARNING

(71) Applicant: THE REGENTS OF THE UNIVERSITY OF CALIFORNIA, Oakland, CA (US)

(72) Inventors: Aydogan Ozcan, Los Angeles, CA (US); Yair Rivenson, Los Angeles, CA (US); Yilin Luo, Los Angeles, CA (US); Luzhe Huang, Los Angeles, CA (US)

(73) Assignee: THE REGENTS OF THE UNIVERSITY OF CALIFORNIA, Oakland, CA (US)

(21) Appl. No.: 17/908,864

(22) PCT Filed: Mar. 18, 2021
(86) PCT No.: PCT/US2021/023040

§ 371 Date: Sep. 1, 2022

Related U.S. Application Data
(60) Provisional application No. 62/992,831, filed on Mar. 20, 2020.

(51) Int. Cl. H04N 5/232; G06N 3/08; G06T 5/00; G02B 21/36

(52) U.S. Cl. CPC H04N 5/23212; G06N 3/08; G06T 5/003; G02B 21/367; G06T 2207/10056; G06T 2207/10064; G06T 2207/20081; G06T 2207/20084; G06T 2207/30024

(57) ABSTRACT

A deep learning-based offline autofocusing method and system is disclosed herein, termed a Deep-R trained neural network, that is trained to rapidly and blindly autofocus a single-shot microscopy image of a sample or specimen that is acquired at an arbitrary out-of-focus plane. The efficacy of Deep-R is illustrated using various tissue sections that were imaged using fluorescence and brightfield microscopy modalities and demonstrate single snapshot autofocusing under different scenarios, such as a uniform axial defocus as well as a sample tilt within the field-of-view. Deep-R is significantly faster when compared with standard online algorithmic autofocusing methods. This deep learning-based blind autofocusing framework opens up new opportunities for rapid microscopic imaging of large sample areas, also reducing the photon dose on the sample.

### RELATED APPLICATION

This application claims priority to U.S. Provisional Patent Application No. 62/992,831 filed on Mar. 20, 2020, which is hereby incorporated by reference. Priority is claimed pursuant to 35 U.S.C. § 119 and any other applicable statute.

### TECHNICAL FIELD

The technical field generally relates to systems and methods used to autofocus microscopic images. In particular, the technical field relates a deep learning-based method of autofocusing microscopic images using a single-shot microscopy image of a sample or specimen that is acquired at an arbitrary out-of-focus plane.

### BACKGROUND

A critical step in microscopic imaging over an extended spatial or temporal scale is focusing. For example, during longitudinal imaging experiments, focus drifts can occur as a result of mechanical or thermal fluctuations of the microscope body or microscopic specimen movement when for example live cells or model organisms are imaged. Another frequently encountered scenario which also requires autofocusing is due to the nonuniformity of the specimen's topography. Manual focusing is impractical, especially for microscopic imaging over an extended period of time or a large specimen area.

Conventionally, microscopic autofocusing is performed “online”, where the focus plane of each individual field-of-view (FOV) is found during the image acquisition process. Online autofocusing can be generally categorized into two groups: optical and algorithmic methods. Optical methods typically adopt additional distance sensors involving e.g., a near-infrared laser, a light-emitting diode or an additional camera, that measure or calculate the relative sample distance needed for the correct focus. These optical methods require modifications to the optical imaging system, which are not always compatible with the existing microscope hardware. Algorithmic methods, on the other hand, extract an image sharpness function/measure at different axial depths and locate the best focal plane using an iterative search algorithm (e.g., illustrated in FIG. 3A). However, the focus function is in general sensitive to the image intensity and contrast, which in some cases can be trapped in a false local maxima/minima. Another limitation of these algorithmic autofocusing methods is the requirement to capture multiple images through an axial scan (search) within the specimen volume. This process is naturally time-consuming, does not support high frame-rate imaging of dynamic specimen and increases the probability of sample photobleaching, photodamage or phototoxicity. As an alternative, wavefront sensing-based autofocusing techniques also lie at the intersection of optical and algorithmic methods. However, multiple image capture is still required, and therefore these methods also suffer from similar problems as the other algorithmic autofocusing methods face.

In recent years, deep learning has been demonstrated as a powerful tool in solving various inverse problems in microscopic imaging, for example, cross-modality super-resolution, virtual staining, localization microscopy, phase recovery and holographic image reconstruction. Unlike most inverse problem solutions that require a carefully formulated forward model, deep learning instead uses image data to indirectly derive the relationship between the input and the target output distributions. Once trained, the neural network takes in a new sample's image (input) and rapidly reconstructs the desired output without any iterations, parameter tuning or user intervention.

Motivated by the success of deep learning-based solutions to inverse imaging problems, recent works have also explored the use of deep learning for online autofocusing of microscopy images. Some of these previous approaches combined hardware modifications to the microscope design with a neural network; for example, Pinkard et al. designed a fully connected Fourier neural network (FCFNN) that utilized additional off-axis illumination sources to predict the axial focus distance from a single image. See Pinkard, H., Phillips, Z., Babakhani, A., Fletcher, D. A. & Waller, L. Deep learning for single-shot autofocus microscopy, Optica 6, 794-797 (2019). As another example, Jiang et al. treated autofocusing as a regression task and employed a convolutional neural network (CNN) to estimate the focus distance without any axial scanning. See Jiang, S. et al. Transform- and multi-domain deep learning for single-frame rapid autofocusing in whole slide imaging, Biomed. Opt. Express 9, 1601-1612 (2018). Dastidar et al. improved upon this idea and proposed to use the difference of two defocused images as input to the neural network, which showed higher focusing accuracy. See Dastidar, T. R. & Ethirajan, R. Whole slide imaging system using deep learning-based automated focusing, Biomed. Opt. Express 11, 480-491 (2020). However, in the case of an uneven or tilted specimen in the FOV, all the techniques described above are unable to bring the whole region into focus simultaneously. Recently, a deep learning based virtual re-focusing method which can handle non-uniform and spatially-varying blurs has also been demonstrated. See Wu, Y. et al., Three-dimensional virtual refocusing of fluorescence microscopy images using deep learning, Nat. Methods (2019) doi:10.1038/s41592-019-0622-5. By appending a pre-defined digital propagation matrix (DPM) to a blurred input image, a trained neural network can digitally refocus the input image onto a user-defined 3D surface that is mathematically determined by the DPM. This approach, however, does not perform autofocusing of an image as the DPM is user-defined, based on the specific plane or 3D surface that is desired at the network output.

Other post-processing methods have also been demonstrated to restore a sharply focused image from an acquired defocused image. One of the classical approaches that has been frequently used is to treat the defocused image as a convolution of the defocusing point spread function (PSF) with the in-focus image. Deconvolution techniques such as the Richardson-Lucy algorithm require accurate prior knowledge of the defocusing PSF, which is not always available. Blind deconvolution methods can also be used to restore images through the optimization of an objective function; but these methods are usually computationally costly, sensitive to image signal-to-noise ratio (SNR) and the choice of the hyperparameters used, and are in general not useful if the blur PSF is spatially varying. There are also some emerging methods that adopt deep learning for blind estimation of a space-variant PSF in optical microscopy.

### SUMMARY

Here, a deep-learning based offline autofocusing system and method is disclosed, termed Deep-R (FIG. 3B), that enables the blind transformation of a single-shot defocused microscopy image of a sample or specimen into an in-focus image without prior knowledge of the defocus distance, its direction, or the blur PSF, whether it is spatially-varying or not. Compared to the existing body of autofocusing methods that have been used in optical microscopy, this Deep-R is unique in a number of ways: (1) it does not require any hardware modifications to an existing microscope design; (2) it only needs a single image capture to infer and synthesize the in-focus image, enabling higher imaging throughput and reduced photon dose on the sample, without sacrificing the resolution; (3) its autofocusing is based on a data-driven, non-iterative image inference process that does not require prior knowledge of the forward imaging model or the defocus distance; and (4) it is broadly applicable to blindly autofocus spatially uniform and non-uninform defocused images, computationally extending the depth of field (DOF) of the imaging system.

Deep-R is based, in one embodiment, on a generative adversarial network (GAN) framework that is trained with accurately paired in-focus and defocused image pairs. After its training, the generator network (of the trained deep neural network) rapidly transforms a single defocused fluorescence image into an in-focus image. The performance of Deep-R trained neural network was demonstrated using various fluorescence (including autofluorescence and immunofluorescence) and brightfield microscopy images with spatially uniform defocus as well as non-uniform defocus within the FOV. The results reveal that the system and method that utilizes the Deep-R trained neural network significantly enhances the imaging speed of a benchtop microscope by ˜15-fold by eliminating the need for axial scanning during the autofocusing process.

Importantly, the work of the autofocusing method is performed offline (in the training of the Deep-R network) and does not require the presence of complicated and expensive hardware components or computationally intensive and time-consuming algorithmic solutions. This data-driven offline autofocusing approach is especially useful in high-throughput imaging over large sample areas, where focusing errors inevitably occur, especially over longitudinal imaging experiments. With Deep-R, the DOF of the microscope and the range of usable images can be significantly extended, thus reducing the time, cost and labor required for reimaging of out-of-focus areas of a sample. Simple to implement and purely computational, Deep-R can be applicable to a wide range of microscopic imaging modalities, as it requires no hardware modifications to the imaging system.

In one embodiment, a method of autofocusing a defocused microscope image of a sample or specimen includes providing a trained deep neural network that is executed by image processing software using one or more processors, the trained deep neural network comprising a generative adversarial network (GAN) framework trained using a plurality of matched pairs of (1) defocused microscopy images, and (2) corresponding ground truth focused microscopy images. A single defocused microscopy input image of the sample or specimen is input to the trained deep neural network. The trained deep neural network then outputs a focused output image of the sample or specimen from the trained deep neural network.

In another embodiment, a system for outputting autofocused microscopy images of a sample or specimen includes a computing device having image processing software executed thereon, the image processing software comprising a trained deep neural network that is executed using one or more processors of the computing device, wherein the trained deep neural network comprises a generative adversarial network (GAN) framework trained using a plurality of matched pairs of (1) defocused microscopy images, and (2) corresponding ground truth focused microscopy images, the image processing software configured to receive a single defocused microscopy input image of the sample or specimen and outputting a focused output image of the sample or specimen from the trained deep neural network. The computing device may be integrated with or associated with a microscope that is used to obtain the defocused images.

### BRIEF DESCRIPTION OF THE DRAWINGS

FIG. 1 illustrates a system and method that uses the Deep-R autofocusing method. A sample or specimen is imaged with a microscope and generates a single defocused image. This defocused image is input to the trained deep neural network (Deep-R) that is executed by one or more processors of a computing device. The trained deep neural network outputs the autofocused microscopy image of the sample or specimen.

FIG. 2 illustrates how the deep neural network (Deep-R) is trained with pairs of defocused and focused images. Once trained, the deep neural network receives defocused images of a sample or specimen and quickly generates or outputs corresponding focused images the sample or specimen. These may include spatially uniform or spatially non-uniform, defocused images.

FIG. 3A schematically illustrates the standard (prior art) autofocusing workflow that uses mechanical autofocusing of a microscope which requires multiple image acquisition at different axial locations.

FIG. 3B schematically illustrates the operation of the Deep-R autofocusing method that utilizes a single defocused image that is input into a trained deep neural network (e.g., GAN) that blindingly autofocuses the defocused image after its capture. The result is a virtually focused image.

FIGS. 4A-4C illustrate Deep-R based autofocusing of fluorescently stained samples. FIG. 4A illustrates how Deep-R trained neural network performs blind autofocusing of individual fluorescence images without prior knowledge of their defocus distances or directions (in this case defocused at −4 μm and +4 μm). Scale bars, 10 μm. FIG. 4B illustrates that for the specific ROI in FIG. 4A, the SSIM and RMSE values of input and output images with respect to the ground truth (z=0 μm, in-focus image) are plotted as a function of the axial defocus distance. The central zone (C) indicates that the axial defocus distance is within the training range while the outer zones (O) indicates that the axial range is outside of the training defocus range. FIG. 4C illustrates corresponding input and output images at various axial distances for comparison.

FIG. 5 illustrates how the Deep-R trained neural network is used to autofocus autofluorescence images. Two different ROIs (ROI #1, ROI #2), each with positive and negative defocus distances (z=4 μm and −5 μm and z=3.2 μm and −5 μm), are blindly brought to focus by the trained Deep-R network (z=0 μm). The absolute difference images of the ground truth with respect to Deep-R input and output images are also shown on the right, with the corresponding SSIM and RMSE quantification reported as insets. Scale bars: 20 μm.

FIG. 6A schematically illustrates Deep-R based autofocusing of a non-uniformly defocused fluorescence image (caused by image tilt). Image acquisition of a tilted autofluorescent sample, corresponding to a depth difference of δz=4.356 μm within the FOV.

FIG. 6B illustrates the Deep-R autofocusing results for a tilted sample. Since no real ground truth is available, the maximum intensity projection (MIP) image was used, calculated from N=10 images as the reference image in this case. Top row: autofocusing of an input image where the upper region is blurred due to the sample tilt. Second row: autofocusing of an input image where the lower region is blurred due to the sample tilt. Scale bars, 20 μm. To the right of each of the images are shown graphs that quantitatively evaluated sharpness using a relative sharpness coefficient that compares the sharpness of each pixel row with the baseline (MIP) image as well as the input image shown in.

FIGS. 6C and 6D illustrate relative sharpness obtained at z=0 μm (FIG. 6C) and z=−2.2 μm (FIG. 6D). The statistics were calculated from a testing dataset containing 18 FOVs, each with 512×512 pixels.

FIGS. 7A and 7B illustrates the 3D PSF analysis of Deep-R using 300 nm fluorescent beads. FIG. 7A illustrates how each plane in the input image stack is fed into Deep-R network and blindly autofocused. FIG. 7B illustrates the mean and standard deviations of the lateral FHWM values of the particle images are reported as a function of the axial defocus distance. The statistics are calculated from N 164 individual nanobeads. Green curve: FWHM statistics of the mechanically scanned image stack (i.e., the network input). Red curve: FWHM statistics of the output images calculated using a Deep-R network that is trained with ±5 μm axial defocus range. Blue curve: FWHM statistics of the output images calculated using a Deep-R network that is trained with ±8 μm axial defocus range.

FIG. 8 illustrates a comparison of Deep-R autofocusing with deconvolution techniques. The lateral PSFs at the corresponding defocus distances are provided to the deconvolution algorithms as prior knowledge of the defocus model. Deep-R did not make use of the measured PSF information shown on the far-right column. Scale bars for tissue images, 10 μm. Scale bars for PSF images, 1 μm.

FIG. 9A illustrates Deep-R based autofocusing of brightfield microscopy images. The success of Deep-R is demonstrated by blindly autofocusing various defocused brightfield microscopy images of human prostate tissue sections. Scale bars, 20 μm.

FIG. 9B illustrates the mean and standard deviation of SSIM and RMSE values of the input and output images with respect to the ground truth (z=0 μm, in-focus image) are plotted as a function of the axial defocus distance. The statistics are calculated from a testing dataset containing 58 FOVs, each with 512×512 pixels.

FIGS. 10A and 10B illustrate the comparison of Deep-R autofocusing performance using different defocus training ranges. Mean and standard deviation of RMSE (FIG. 10A) and SSIM (FIG. 10B) values of the input and output images at different defocus distances. Three different Deep-R networks are reported here, each trained with a different defocus range, spanning ±2 μm, ±5 μm, and ±10 μm, respectively. The curves are calculated using 26 unique sample FOVs, each with 512×512 pixels.

FIG. 11 illustrates the Deep-R based autofocusing of a sample with nanobeads dispersed in 3D. 300 nm beads are randomly distributed in a sample volume of ˜20 μm thickness. Using a Deep-R network trained with ±5 μm defocus range, autofocusing on some of these nanobeads failed since they were out of this range. These beads, however, were successfully refocused using a network trained with ±8 μm defocus range. Scale bar: 5 μm.

FIG. 12 illustrates Deep-R based blind autofocusing of images captured at large defocus distances (5-9 μm). Scale bar: 10 μm.

FIG. 13. illustrates the Deep-R neural network architecture illustrated. The network is trained using a generator network and a discriminator network.

FIGS. 14A-14C illustrates how the pixel-by-pixel defocus distance was extracted from an input image in the form of a digital propagation matrix (DPM). FIG. 14A illustrates how a decoder is used to extract defocus distances from Deep-R autofocusing. The Deep-R network is pre-trained and fixed, and then a decoder is separately optimized to learn the pixel-by-pixel defocus distance in the form of a matrix, DPM. FIG. 14B shows the Deep-R autofocusing output and the extracted DPM on a uniformly defocused sample. FIG. 14C illustrates the Deep-R autofocusing output and the extracted DPM for a tilted sample. The dz-y plot is calculated from the extracted DPM. Solid line: the mean dz averaged by each row; shadow: the standard deviation of the estimated dz in each row; straight line: the fitted dz-y line with a fixed slope corresponding to the tilt angle of the sample.

FIG. 15 illustrates the Deep-R network autofocusing on non-uniformly defocused samples. The non-uniformly defocused images were created by Deep-Z, using DPMs that represent tilted, cylindrical and spherical surfaces. The Deep-R network was able to focus images of the particles on the representative tilted, cylindrical, and spherical surfaces.

FIGS. 16A-16D illustrate Deep-R generalization to new sample types. Three separately trained Deep-R networks with a defocus range of 10 μm were trained on three (3) different datasets that contain images of only nuclei, only phalloidin and both types of images. The networks were then blindly tested on different types of samples. FIG. 16A shows sample images of nuclei and phalloidin. FIG. 16B illustrates the input and output of the three networks are compared under the RMSE value with respect to the ground truth (z=0 μm). □ curve: network input. Δ Curve: output from the network that did not train on the type of sample. ** curve: output from the network trained with a mixed type of samples. * curve: output from the network trained with the type of sample. FIG. 16C illustrates Deep-R outputs from a model trained with nuclei images brings back some details when tested on phalloidin images. However, the autofocusing is not optimal, compared with the reconstruction using a model that was trained only with phalloidin images. FIG. 16D shows zoomed-in regions of the ground truth, input and Deep-R output images in FIG. 16D. The frame from FIG. 16A highlights the selected region.

FIGS. 17A-17D illustrate the training (FIGS. 17A, 17B) and validation loss (FIGS. 17C, 17D) curves as a function of the training iterations. Deep-R was trained from scratch on breast tissue sample dataset. For easier visualization, the loss curves are smoothed using a Hanning window of size 1200. Due to the least square form of the discriminator loss, the equilibrium is reached when L_{D}≈0.25. Optimal model was reached at ˜80,000 iterations.

### DETAILED DESCRIPTION OF ILLUSTRATED EMBODIMENTS

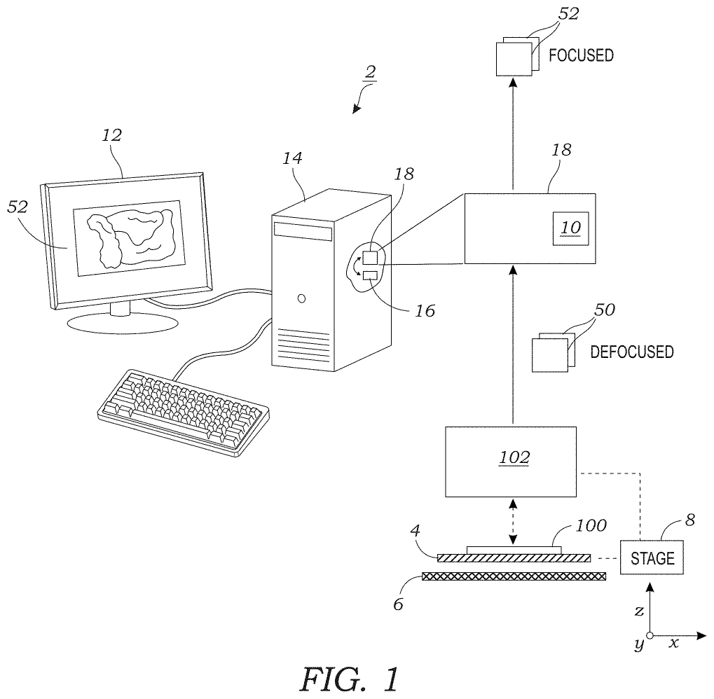

FIG. 1 illustrates a system 2 that uses the Deep-R autofocusing method described herein. A sample or specimen 100 is imaged with a microscope 102 and generates a single defocused image 50 (or in other embodiments multiple defocused images 50). The defocused image 50 may be defocused on either side of the desired focal plane (e.g., negatively defocused (−) or positively defocused (+)). The defocused image 50 may be defocused images 50 that are spatially uniform or spatially non-uniformly. Examples of spatial non-uniformity include images of a sample or specimen 100 that are tilted or located on a cylindrical or spherical surface (e.g., sample holder 4). The sample or specimen 100 may include tissue blocks, tissue sections, particles, cells, bacteria, viruses, mold, algae, particulate matter, dust or other micro-scale objects a sample volume. In one particular example, the sample or specimen 100 may be fixed or the sample or specimen 100 may be unaltered. The sample or specimen 100 may, in some embodiments, contain an exogenous or endogenous fluorophore. The sample or specimen 100 may, in other embodiments, comprise a stained sample. Typically, the sample or specimen 100 is placed on a sample holder 4 that may include an optically transparent substrate such as a glass or plastic slide.

A microscope 102 is used to obtain, in some embodiments, a single defocused image 50 of the sample or specimen 100 that is then input to a trained deep neural network 10 which generates or outputs a corresponding focused image 52 of the sample or specimen 100. It should be appreciated that a focused image 52 (including focused ground truth images 51 discussed below) refers to respective images that are in-focus. Images are obtained with at least one image sensor 6 as seen in FIG. 1. While only a single defocused image of the sample or specimen 100 is needed to generate the focused image of the sample or specimen 100, it should be appreciated that multiple defocused images may be obtained and then input to the trained deep neural network 10 to generate corresponding focused output images 52 (e.g., as illustrated in FIG. 1). For example, a sample or specimen 100 may need to be scanned by a microscope 102 whereby a plurality of images of different regions or areas of the sample or specimen 100 are obtained and then digitally combined or stitched together to create an image of the sample or specimen 100 or regions thereof. FIG. 1, for example, illustrates a moveable stage 8 that is used to scan the sample or specimen 100. For example, the moveable stage 8 may impart relative motion between the sample or specimen 100 and the optics of the microscope 102. Movement in the x and y directions allows the sample or specimen 100 to be scanned. In this way, the system 2 and methods described herein may be used to take the different defocused images 50 of the sample or specimen 100 which are then combined to create a larger image of a particular region-of-interest of the sample or specimen 100 (or the entire sample or specimen 100). The moveable stage 8 may also be used movement in the z direction for adjusting for tilt of the sample or specimen 100 or for rough focusing of the sample or specimen 100. Of course, as explained herein, there is no need for multiple images in the z direction to generate the focused image 52 of the sample or specimen 100.

The microscope 102 may include any number of microscope types including, for example, a fluorescence microscope, a brightfield microscope, a super-resolution microscope, a confocal microscope, a light-sheet microscope, a darkfield microscope, a structured illumination microscope, a total internal reflection microscope, and a phase contrast microscope. The microscope 102 includes one or more image sensors 6 that are used to capture the individual defocused image(s) 50 of the sample or specimen 100. The image sensor 6 may include, for example, commercially available complementary metal oxide semiconductor (CMOS) image sensors, or charge-coupled device (CCD) sensors. The microscope 102 may also include a whole slide scanning microscope that autofocuses microscopic images of tissue samples. This may include a scanning microscope that autofocuses smaller image field-of-views of a sample or specimen 100 (e.g., tissue sample) that are then stitched or otherwise digitally combined using image processing software 18 to create a whole slide image of the tissue. A single image 50 is obtained from the microscope 102 that is defocused in one or more respects. Importantly, one does not need to know of the defocus distance, its direction (i.e., + or −), or the blur PSF, or whether it is spatially-varying or not.

FIG. 1 illustrates a display 12 that is connected to a computing device 14 that is used, in one embodiment, to display the focused images 52 generated from the trained deep neural network 10. The focused images 52 may be displayed with a graphical user interface (GUI) allowing the user to interact with the focused image 52. For example, the user can highlight, select, crop, adjust the color/hue/saturation of the focused image 52 using menus or tools as is common in visual editing software. In one aspect, the computing device 14 that executes the trained deep neural network 10 is also used to control the microscope 102. The computing device 14 may include, as explained herein, a personal computer, laptop, remote server, or the like, although other computing devices may be used (e.g., devices that incorporate one or more graphic processing units (GPUs)). Of course, the computing device 14 that executes the trained deep neural network 10 may be separate from any computer or computing device that operates the microscope 102. The computing device 14 includes one or more processors 16 that execute image processing software 18 that includes the trained deep neural network 10. The one or more processors 16 may include, for example, a central processing unit (CPU) and/or a graphics processing unit (GPU). As explained herein, the image processing software 18 can be implemented using Python and TensorFlow although other software packages and platforms may be used. The trained deep neural network 10 is not limited to a particular software platform or programming language and the trained deep neural network 10 may be executed using any number of commercially available software languages or platforms. The image processing software 18 that incorporates or runs in coordination with the trained deep neural network 10 may be run in a local environment or a remote cloud-type environment. For example, images 50 may be transmitted to a remote computing device 14 that executes the image processing software 18 to output the focused images 52 which can be viewed remotely or returned to the user to a local computing device 14 for review. Alternatively, the trained deep neural network 10 may be executed locally on a local computing device 14 that is co-located with the microscope 102.

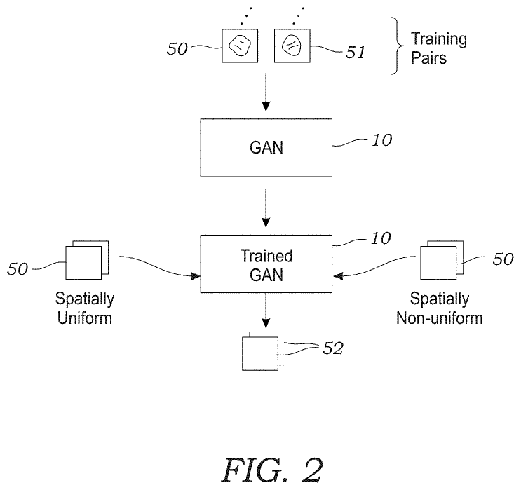

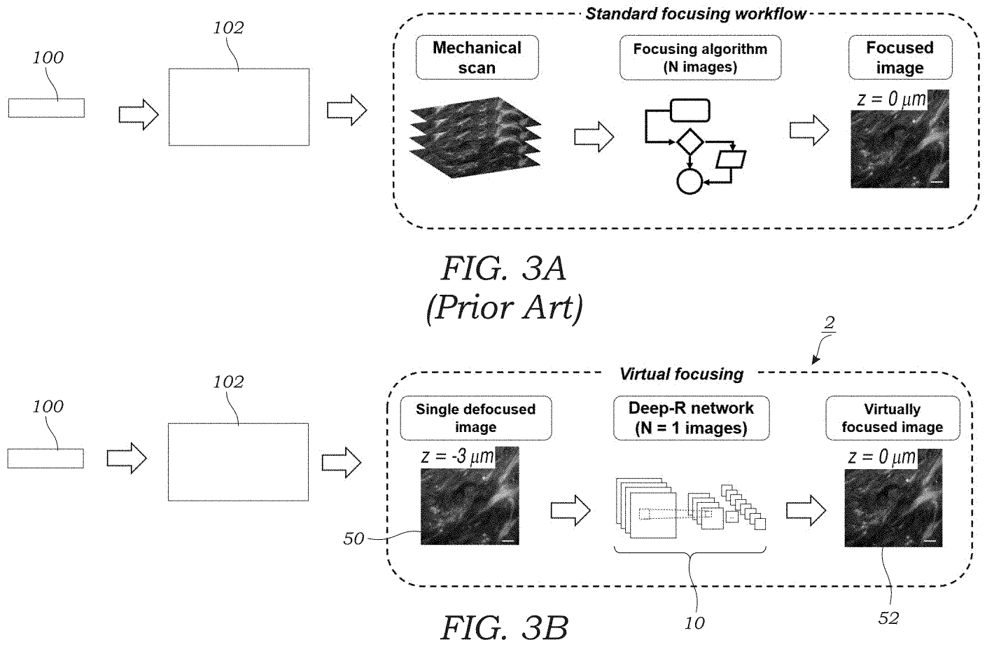

As explained herein, the deep neural network 10 is trained using a generative adversarial network (GAN) framework in a preferred embodiment. This GAN 10 is trained using a plurality of matched pairs of (1) defocused microscopy images 50, and (2) corresponding ground truth or target focused microscopy images 51 as illustrated in FIG. 2. The defocused microscopy images 50 are accurately paired with in-focus microscopy images 51 as image pairs.

Note that for training of the trained deep neural network 10, the defocused microscopy images 50 that are used for training may include spatially uniform defocused microscopy images 50. The resultant trained deep neural network 10 that is created after training may be input with defocused microscopy images 50 that are spatially uniform or spatially non-uniform. That is to say, even though the deep neural network 10 was trained only with spatially uniform defocused microscopy images 50, the final trained neural network 10 is still able to generate focused images 52 from input defocused images 50 that are spatially non-uniform. The trained deep neural network 10 thus has general applicability to a broad set of input images. Separate training of the deep neural network 10 for spatially non-uniform, defocused images is not needed as trained deep neural network 10 is still able to accommodate these different image types despite having never been specifically trained on them.

As explained herein, each defocused image 50 is input to the trained deep neural network 10. The trained deep neural network 10 rapidly transforms a single defocused image 50 into an in-focus image 52. Of course, while only a single defocused image 50 is run through the trained deep neural network 10, multiple defocused images 50 may be input to the trained deep neural network 10. In one particular embodiment, the autofocusing performed by the trained deep neural network 10 is performed very quickly, e.g., over a few or several seconds. For example, prior online algorithms may take on the order of ˜40 s/mm² to autofocus. This compares with the Deep-R system 2 and method described herein that doubles this speed (e.g., ˜20 s/mm²) using the same CPU. Implementation of the method using a GPU processor 16 may improve the speed even further (e.g., ˜3 s/mm²). The focused image 52 that is output by the trained deep neural network 10 may be displayed on a display 12 for a user or may be saved for later viewing. The autofocused image 52 may be subject to other image processing prior to display (e.g., using manual or automatic image manipulation methods). Importantly, the Deep-R system 2 and method generates improved autofocusing without the need for any PSF information or parameter tuning.

Experimental

Deep-R Based Autofocusing of Defocused Fluorescence Images

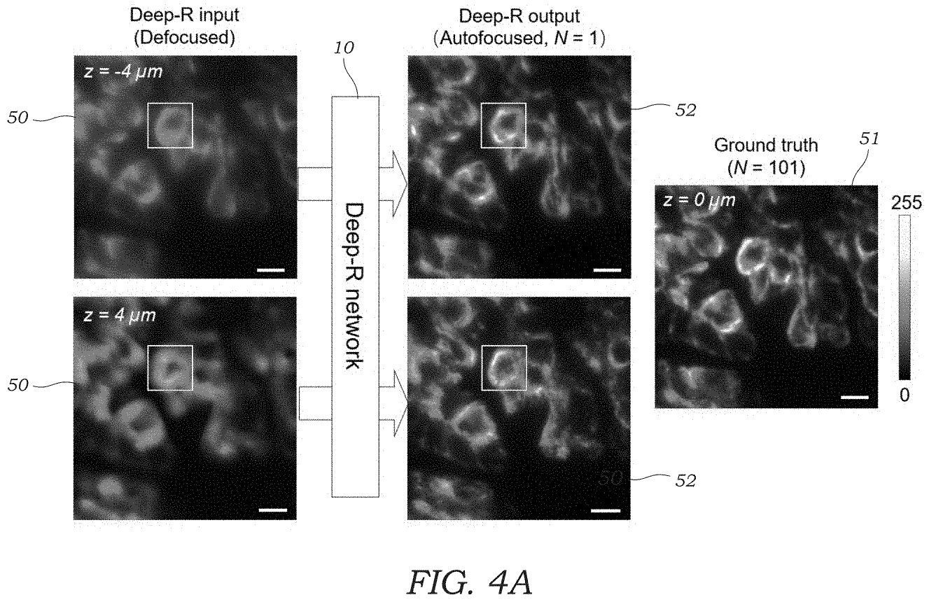

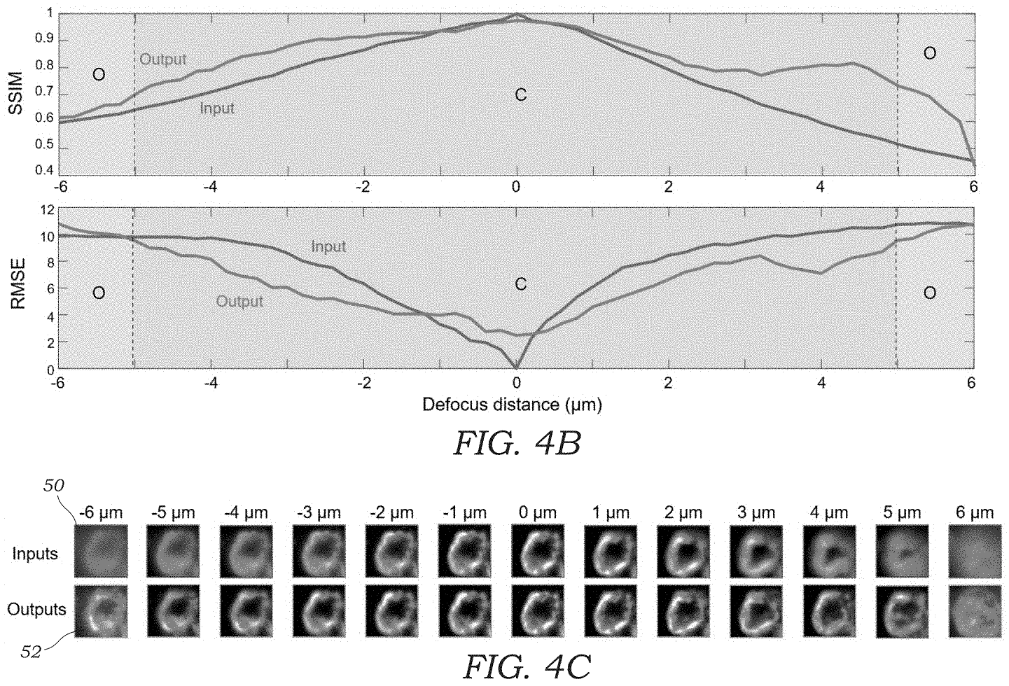

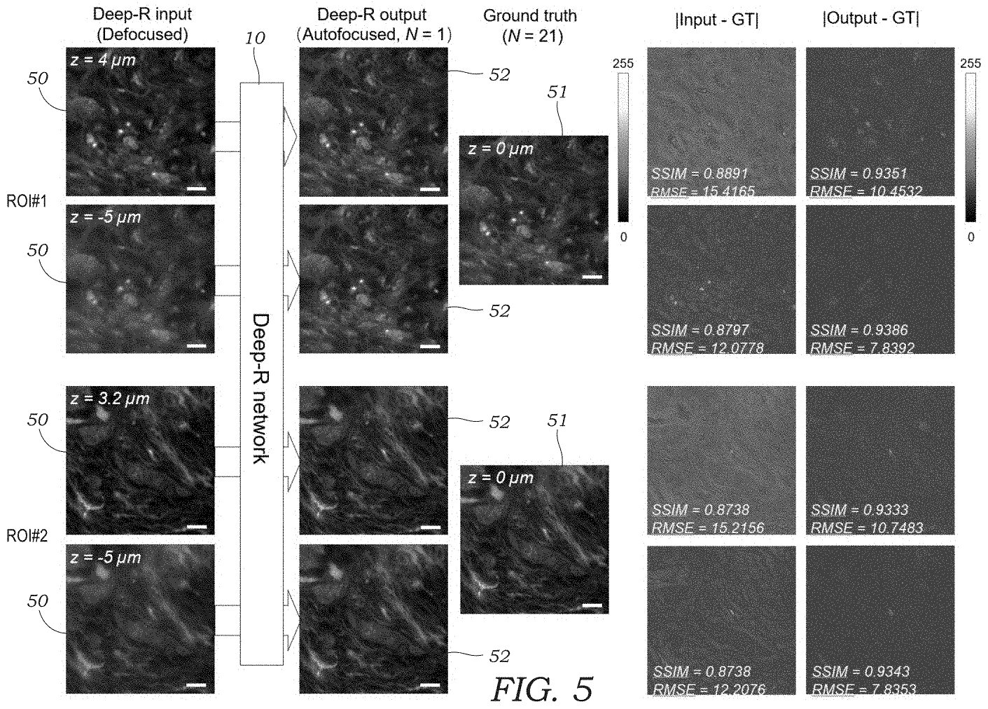

FIG. 4A demonstrates Deep-R based autofocusing of defocused immunofluorescence images 50 of an ovarian tissue section into corresponding focused images 52. In the training stage, the network 10 was fed with accurately paired/registered image data composed of (1) fluorescence images acquired at different axial defocus distances, and (2) the corresponding in-focus images (ground-truth labels), which were algorithmically calculated using an axial image stack (N=101 images captured at different planes; see the Materials and Methods section). During the inference process, a pretrained Deep-R network 10 blindly takes in a single defocused image 50 at an arbitrary defocus distance (within the axial range included in the training), and digitally autofocuses it to match the ground truth image. FIG. 4B highlights a sample region of interest (ROI) to illustrate the blind output of the Deep-R network 10 at different input defocus depths. Within the ±5 μm axial training range, Deep-R successfully autofocuses the input images 50 and brings back sharp structural details in the output images 52, e.g., corresponding to SSIM (structural similarity index) values above 0.7, whereas the mechanically scanned input images degrade rapidly, as expected, when the defocus distance exceeds ˜0.65 μm, which corresponds to the DOF of the objective lens (40×/0.95NA). Even beyond its axial training range, Deep-R output images 52 still exhibit some refocused features, as illustrated in FIGS. 4B and 4C. Similar blind inference results were also obtained for a densely-connected human breast tissue sample (see FIG. 5) that is imaged under a 20×/0.75NA objective lens, where Deep-R accurately autofocused the autofluorescence images of the sample within an axial defocus range of ±5 μm.

Deep-R Based Autofocusing of Non-Uniformly Defocused Images

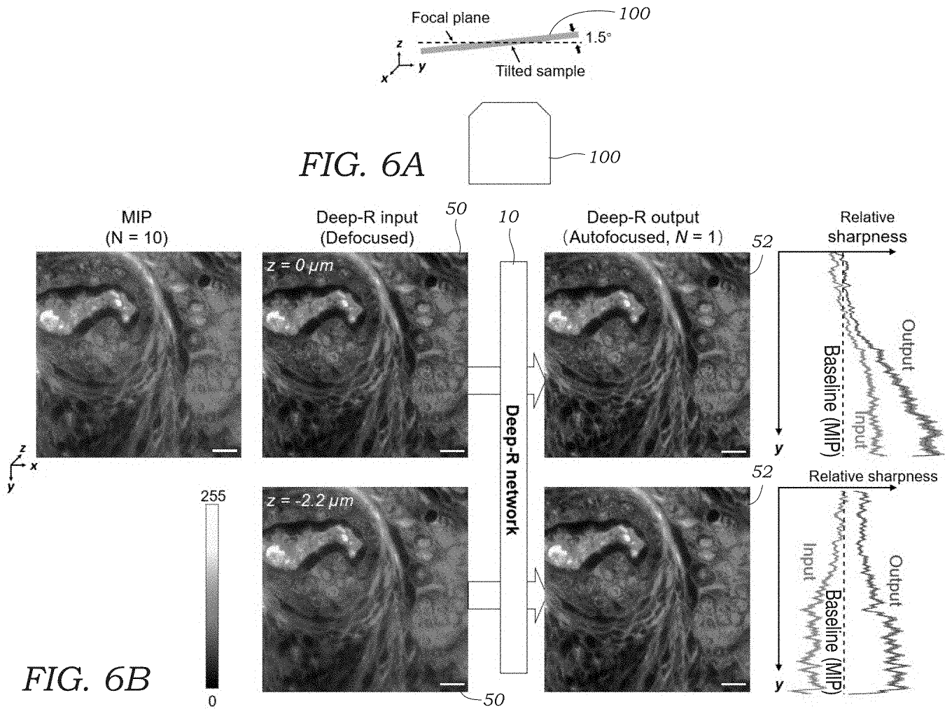

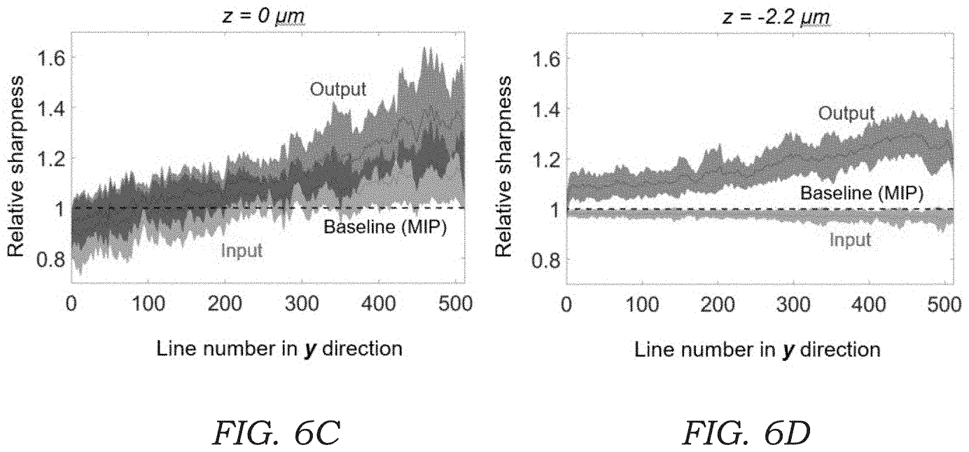

Although Deep-R is trained on uniformly defocused microscopy images 50, during blind testing it can also successfully autofocus non-uniformly defocused images 50 without prior knowledge of the image distortion or defocusing. As an example, FIG. 6A illustrates Deep-R based autofocusing of a non-uniformly defocused image 50 of a human breast tissue sample that had ˜1.5° planar tilt (corresponding to an axial difference of δz=4.356 μm within the effective FOV of a 20×/0.75NA objective lens). This Deep-R network 10 was trained using only uniformly defocused images 50 and is the same network 10 that generated the results reported in FIG. 5. As illustrated in FIG. 6B, at different focal depths (e.g., z=0 μm and z=−2.2 μm), because of the sample tilt, different sub-regions within the FOV were defocused by different amounts, but they were simultaneously autofocused by Deep-R, all in parallel, generating an extended DOF image that matches the reference image (FIG. 6B, see the Materials and Methods section). Moreover, the focusing performance of Deep-R on this tilted sample was quantified using a row-based sharpness coefficient (FIG. 6B sharpness graphs at right, see the Materials and Methods section), which reports, row by row, the relative sharpness of the output (or the input) images with respect to the reference image along the direction of the sample tilt (i.e., y-axis). As demonstrated in FIG. 6B, Deep-R output images 52 achieved a significant increase in sharpness measure within the entire FOV, validating Deep-R's autofocusing capability for a non-uniformly defocused, tilted sample. FIG. 6B graphs were calculated on a single sample FOV; FIGS. 6C and 6D reports the statistical analysis of Deep-R results on the whole image dataset consisting of 18 FOVs that are each non-uniformly defocused, confirming the same conclusion as in FIG. 6B.

Point Spread Function Analysis of Deep-R Performance

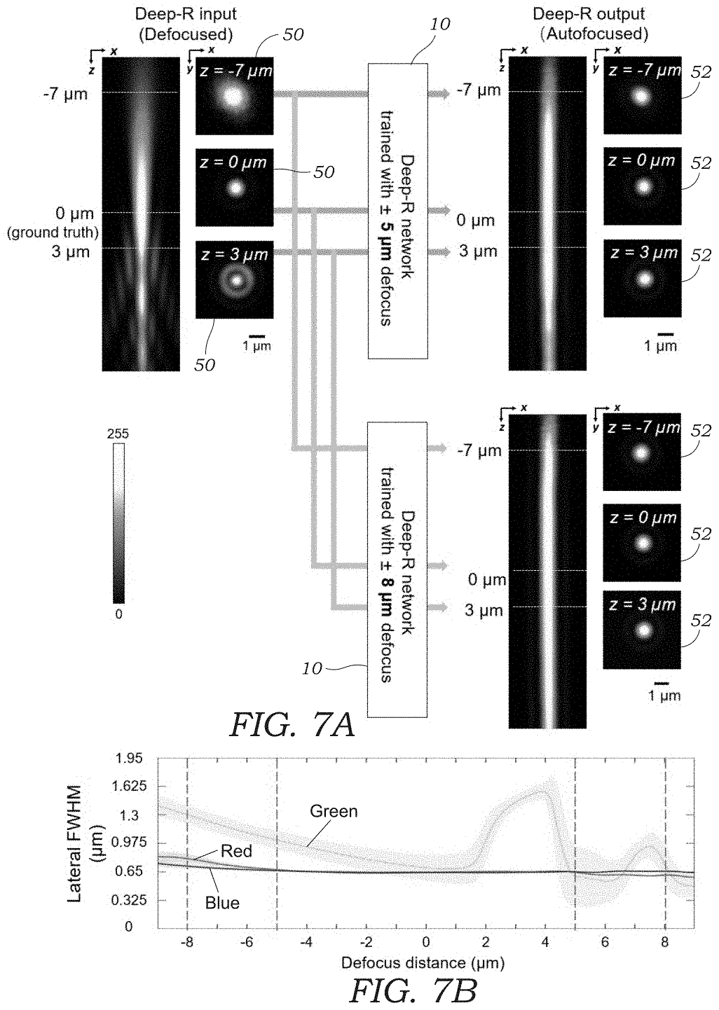

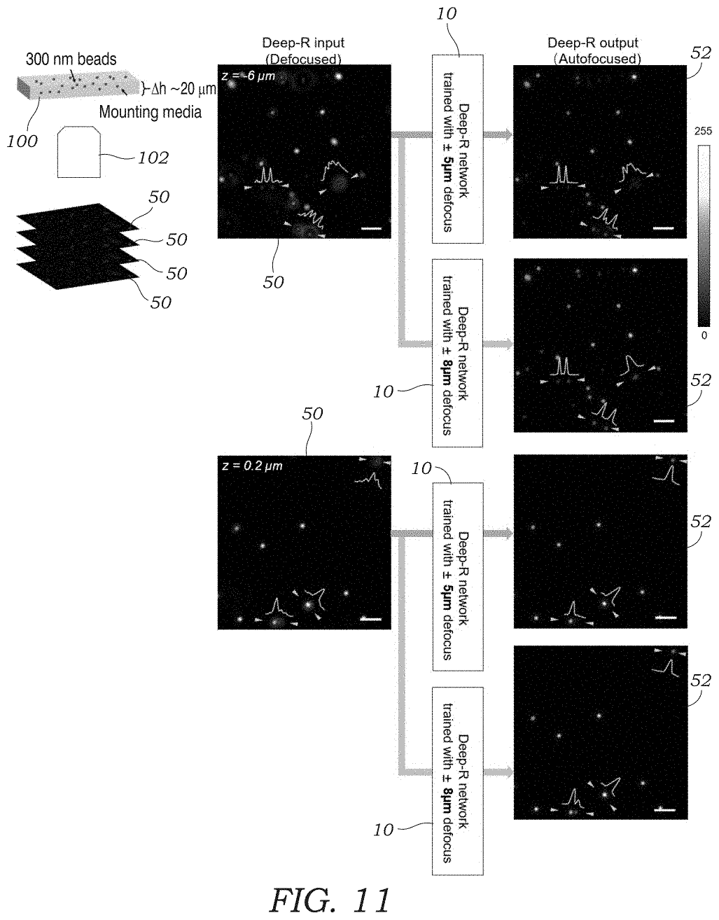

To further quantify the autofocusing capability of Deep-R, samples containing 300 nm polystyrene beads (excitation and emission wavelengths of 538 nm and 584 nm, respectively) were imaged using a 40×/0.95NA objective lens and trained two different neural networks with an axial defocus range of ±5 μm and ±8 μm, respectively. After the training phase, the 3D PSF of the input image stack was measured and the corresponding Deep-R output image stack by tracking 164 isolated nanobeads across the sample FOV as a function of the defocus distance. For example, FIG. 7A illustrates the 3D PSF corresponding to a single nanobead, measured through this axial image stack (input images). As expected, this input 3D PSF shows increased spreading away from the focal plane. On the other hand, the Deep-R PSF corresponding to the output image stack of the same particle maintains a tighter focus, covering an extended depth, determined by the axial training range of the Deep-R network (see FIG. 7A). As an example, at z=−7 μm, the output images of a Deep-R network that is trained with ±5 μm defocus range exhibit slight defocusing (see FIG. 7B), as expected. However, using a Deep-R network 10 trained with ±8 μm defocus range results in accurate refocusing for the same input images 50 (FIG. 7B). Similar conclusions were observed for the blind testing of a 3D sample, where the nanobeads were dispersed within a volume spanning ˜20 μm thickness (see FIG. 11).

FIG. 7B further presents the mean and standard deviation of the lateral full width at half maximum (FWHM) values as a function of the axial defocus distance, calculated from 164 individual nanobeads. The enhanced DOF of Deep-R output is clearly illustrated in the nearly constant lateral FHWM within the training range. On the other hand, the mechanically scanned input images show much shallower DOF, as reflected by the rapid change in the lateral FWHM as the defocus distance varies. Note also that the FWHM curve for the input image is unstable at the positive defocus distances, which is caused by the strong side lobes induced by out-of-focus lens aberrations. Deep-R output images 52, on the other hand, are immune to these defocusing introduced aberrations since it blindly autofocuses the image at its output and therefore maintains a sharp PSF across the entire axial defocus range that lies within its training, as demonstrated in FIG. 7B.

Comparison of Deep-R Computation Time Against Online Algorithmic Autofocusing Methods

While the conventional online algorithmic autofocusing methods require multiple image capture at different depths for each FOV to be autofocused, Deep-R instead reconstructs the in-focus image from a single shot at an arbitrary depth (within its axial training range). This unique feature greatly reduces the scanning time, which is usually prolonged by cycles of image capture and axial stage movement during the focus search before an in-focus image of a given FOV can be captured. To better demonstrate this and emphasize the advantages of Deep-R, the autofocusing time of four (4) commonly used online focusing methods were experimentally measured: Vollath-4 (VOL4), Vollath-5 (VOL5), standard deviation (STD) and normalized variance (NVAR). Table 1 summarizes the results, where an autofocusing time per 1 mm² of sample FOV is reported. Overall, these online algorithms take ˜40 s/mm² to autofocus an image using a 3.5 GHz Intel Xeon E5-1650 CPU, while Deep-R inference takes ˜20 s/mm² on the same CPU, and ˜3 s/mm² on an Nvidia GeForce RTX 2080Ti GPU.

TABLE 1

| | Average time | Standard deviation |
|---|---|---|
| Focusing criterion | (sec/mm²) | (sec/mm²) |
| Vollath4 | 42.91 | 3.16 |
| Vollath5 | 39.57 | 3.16 |
| Standard deviation | 37.22 | 3.07 |
| Normalized variance | 36.50 | 0.36 |
| Deep-R (CPU) | 20.04 | 0.23 |
| Deep-R (GPU) | 2.98 | 0.08 |

Comparison of Deep-R Autofocusing Quality with Offline Deconvolution Techniques

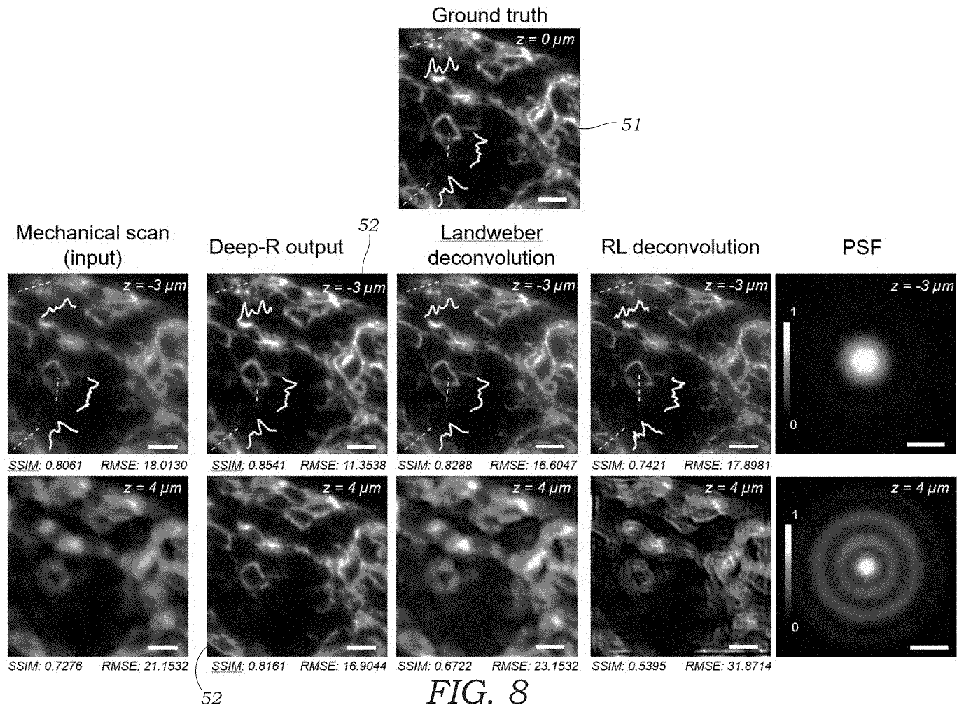

Next, Deep-R autofocusing was compared against standard deconvolution techniques, specifically, the Landweber deconvolution and the Richardson-Lucy (RL) deconvolution, using the ImageJ plugin DeconvolutionLab2 (see FIG. 8). For these offline deconvolution techniques, the lateral PSFs at the corresponding defocus distances were specifically provided using measurement data, since this information is required for both algorithms to approximate the forward imaging model. In addition to this a priori PSF information at different defocusing distances, the parameters of each algorithm were adjusted/optimized such that the reconstruction had the best visual quality for a fair comparison (see the Materials and Methods section). FIG. 8 illustrates that at negative defocus distances (e.g., z=−3 μm), these offline deconvolution algorithms demonstrate an acceptable image quality in most regions of the sample, which is expected, as the input image maintains most of the original features at this defocus direction; however, compared with Deep-R output, the Landweber and RL deconvolution results showed inferior performance (despite using the PSF at each defocus distance as apriori information). A more substantial difference between Deep-R output and these offline deconvolution methods is observed when the input image is positively defocused (see e.g., z=4 μm in FIG. 8). Deep-R performs improved autofocusing without the need for any PSF measurement or parameter tuning, which is also confirmed by the SSIM and RMSE (root mean square error) metrics reported in FIG. 8.

Deep-R Based Autofocusing of Brightfield Microscopy Images

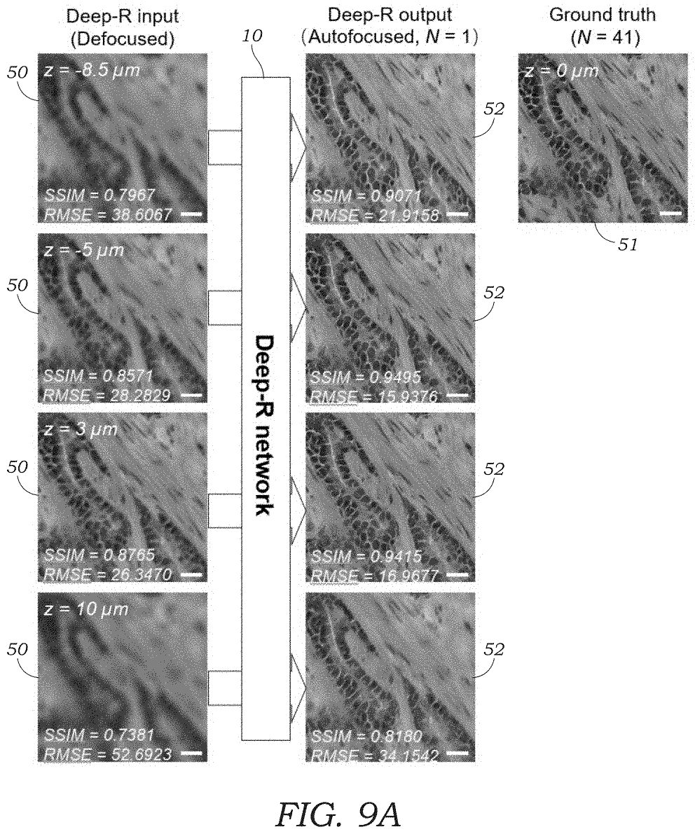

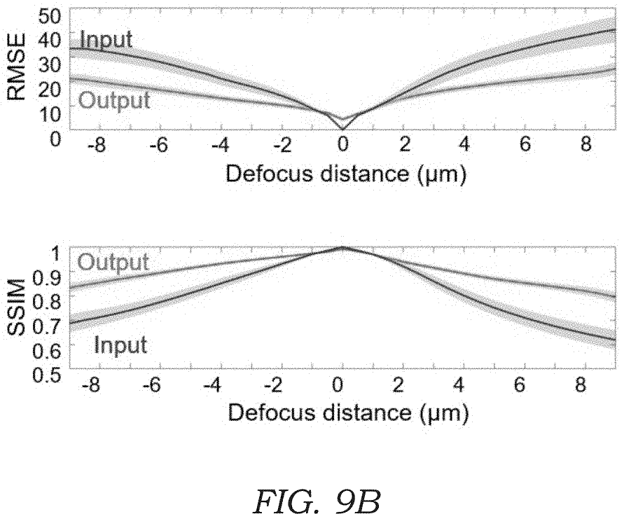

While all the previous results are based on images obtained by fluorescence microscopy, Deep-R can also be applied to other incoherent imaging modalities, such as brightfield microscopy. As an example, the Deep-R framework was applied on brightfield microscopy images 50 of an H&E (hematoxylin and eosin) stained human prostate tissue (FIG. 9A). The training data were composed of images with an axial defocus range of ±10 μm, which were captured by a 20×/0.75NA objective lens. After the training phase, the Deep-R network 10, as before, takes in an image 50 at an arbitrary (and unknown) defocus distance and blindly outputs an in-focus image 52 that matches the ground truth. Although the training images were acquired from a non-lesion prostate tissue sample, blind testing images were obtained from a different sample slide coming from a different patient, which contained tumor, still achieving high RMSE and SSIM accuracy at the network output (see FIGS. 9A and 9B), which indicates the generalization success of the presented method. The application of Deep-R to brightfield microscopy can significantly accelerate whole slide imaging (WSI) systems used in pathology by capturing only a single image at each scanning position within a large sample FOV, thus enabling high-throughput histology imaging.

Deep-R Autofocusing on Non-Uniformly Defocused Samples

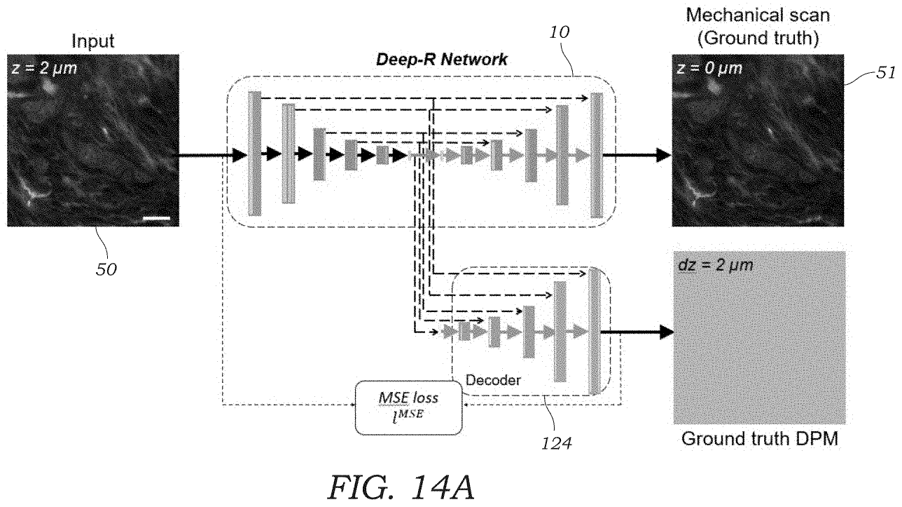

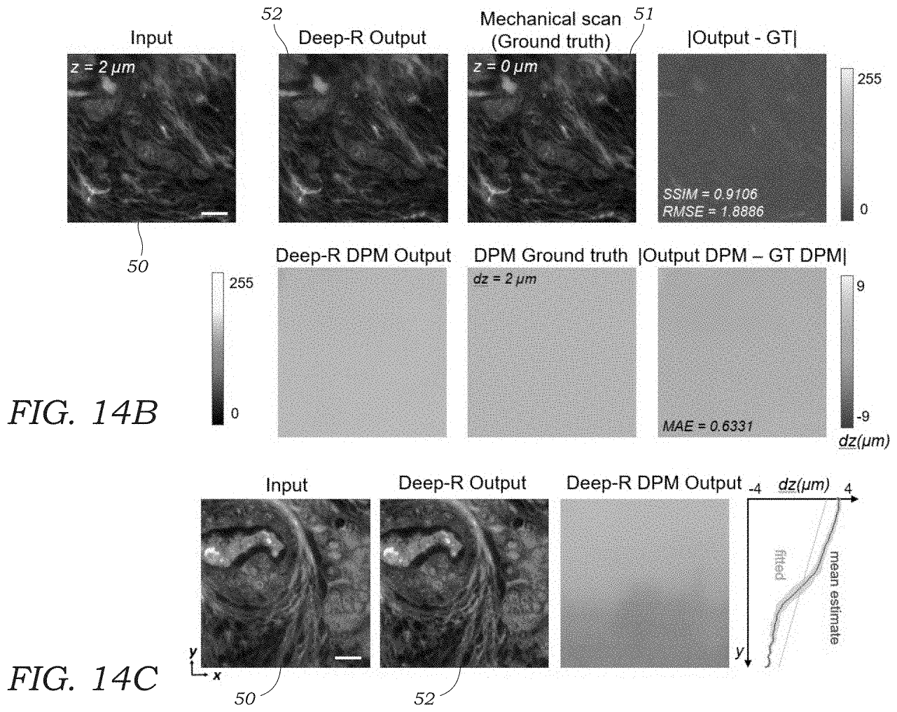

Next, it was demonstrated that the axial defocus distance of every pixel in the input image is in fact encoded and can be inferred during Deep-R based autofocusing in the form of a digital propagation matrix (DPM), revealing pixel-by-pixel the defocus distance of the input image 50. For this, a Deep-R network 10 was first pre-trained without the decoder 124, following the same process as all the other Deep-R networks, and then the parameters of Deep-R were fixed. A separate decoder 124 with the same structure of the up-sampling path of the Deep-R network was separately optimized (see the Methods section) to learn the defocus DPM of an input image 50. The network 10 and decoder 124 system is seen in FIG. 14A. In this optimization/learning process, only uniformly defocused images 50 were used, i.e., the decoder 124 was solely trained on uniform DPMs. Then, the decoder 124, along with the corresponding Deep-R network 10, were both tested on uniformly defocused samples. As seen in FIG. 14B, the output DPM matches the ground truth very well, successfully estimating the axial defocus distance of every pixel in the input image. As a further challenge, despite being trained using only uniformly defocused samples, the decoder was also blindly tested on a tilted sample with a tilt angle of 1.5°, and as presented in FIG. 14C, the output DPM clearly revealed an axial gradient (graph on right side of FIG. 14C), corresponding to the tilted sample plane, demonstrating the generalization of the decoder to non-uniformly defocused samples.

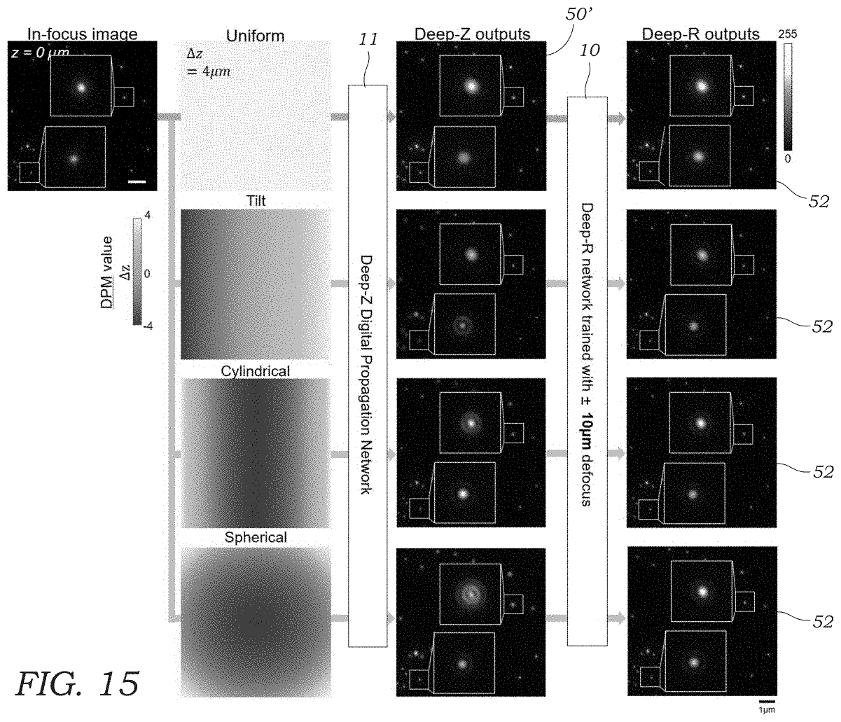

Next, Deep-R was further tested on non-uniformly defocused images that were this time generated using a pre-trained Deep-Z network 11 fed with various non-uniform DPMs that represent tilted, cylindrical and spherical surfaces (FIG. 15). Details regarding the Deep-Z method may be found in Wu et al., Three-dimensional virtual refocusing of fluorescence microscopy images using deep learning, Nat. Methods, 16(12), 1323-31 (2019), which is incorporated herein by reference. Although Deep-R was exclusively trained on uniformly defocused image data, it can handle complex non-uniform defocusing profiles within a large defocusing range, with a search complexity of O(1), successfully autofocusing each one of these non-uniformly defocused images 50′ shown in FIG. 15 in a single blind inference event to generate autofocused images 52. Furthermore, Deep-R network 10 autofocusing performance was also demonstrated using tilted tissue samples as disclosed herein (e.g., FIGS. 6A-6D and accompanying description). As illustrated in FIGS. 6A-6D, at different focal depths (e.g., z=0 m and z=−2.2 μm), because of the tissue sample tilt, different sub-regions within the FOV were defocused by different amounts, but they were simultaneously autofocused by the Deep-R network 10, all in parallel, generating an extended DOF image that matches the reference fluorescence image.

Although trained with uniformly defocused images, the Deep-R trained neural network 10 can successfully autofocus images of samples that have non-uniform aberrations (or spatial aberrations), computationally extending the DOF of the microscopic imaging system. Stated differently, Deep-R is a data-driven, blind autofocusing algorithm that works without prior knowledge regarding the defocus distance or aberrations in the optical imaging system (e.g., microscope 102). This deep learning-based framework has the potential to transform experimentally acquired images that were deemed unusable due to e.g., out-of-focus sample features, into in-focus images, significantly saving imaging time, cost and labor that would normally be needed for re-imaging of such out-of-focus regions of the sample.

In addition to post-correction of out-of-focus or aberrated images, the Deep-R network 10 also provides a better alternative to existing online focusing methods, achieving higher imaging speed. Software-based conventional online autofocusing methods acquire multiple images at each FOV. The microscope captures the first image at an initial position, calculates an image sharpness feature, and moves to the next axial position based on a focus search algorithm. This iteration continues until the image satisfies a sharpness metric. As a result, the focusing time is prolonged, which leads to increased photon flux on the sample, potentially introducing photobleaching, phototoxicity or photodamage. This iterative autofocusing routine also compromises the effective frame rate of the imaging system, which limits the observable features in a dynamic specimen. In contrast, Deep-R performs autofocusing with a single-shot image, without the need for additional image exposures or sample stage movements, retaining the maximum frame rate of the imaging system.

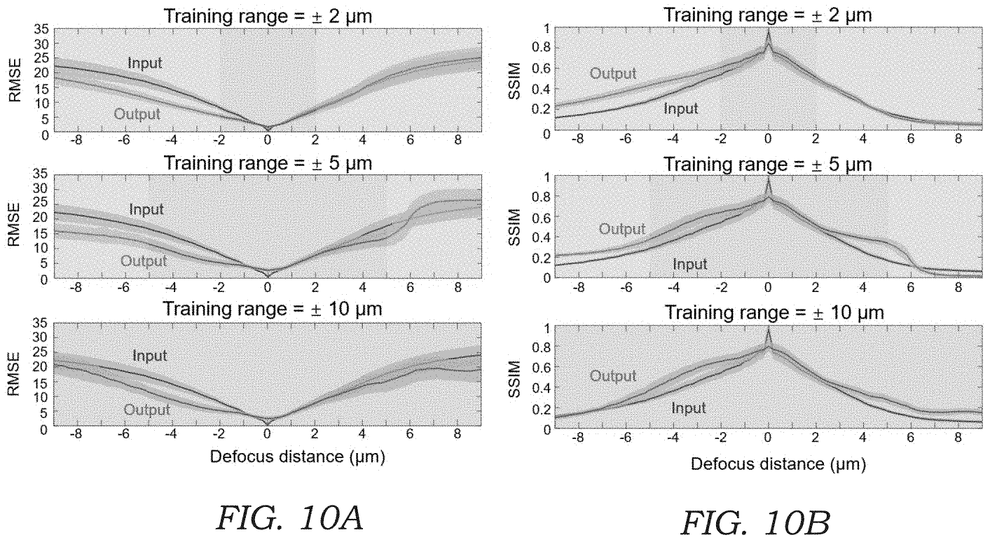

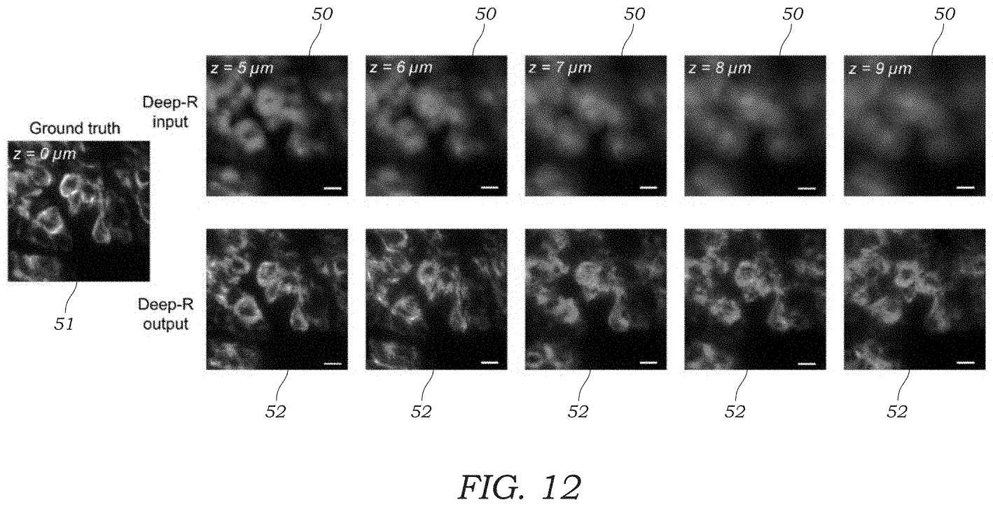

Although the blind autofocusing range of Deep-R can be increased by incorporating images that cover a larger defocusing range, there is a tradeoff between the inference image quality and the axial autofocusing range. To illustrate this tradeoff, three (3) different Deep-R networks 10 were trained on the same immunofluorescence image dataset as in FIG. 4A, each with a different axial defocus training range, i.e., ±2 μm, ±5 μm, and ±10 μm, respectively. FIGS. 10A and 10B reports the average and the standard deviation of RMSE and SSIM values of Deep-R input images 50 and output images 52, calculated from a blind testing dataset consisting of 26 FOVs, each with 512×512 pixels. As the axial training range increases, Deep-R accordingly extends its autofocusing range, as shown in FIGS. 10A and 10B. However, a Deep-R network 10 trained with a large defocus distance (e.g., ±10 μm) partially compromises the autofocusing results corresponding to a slightly defocused image (see e.g., the defocus distances 2-5 μm reported in FIGS. 10A and 10B). Stated differently the blind autofocusing task for the network 10 becomes more complicated when the axial training range increases, yielding a sub-optimal convergence for Deep-R (also see FIG. 12). A possible explanation for this behavior is that as the defocusing range increases, each pixel in the defocused image is receiving contributions from an increasing number of neighboring object features, which renders the inverse problem of remapping these features back to their original locations more challenging. Therefore, the inference quality and the success of autofocusing is empirically related to the sample density as well as the SNR of the acquired raw image.

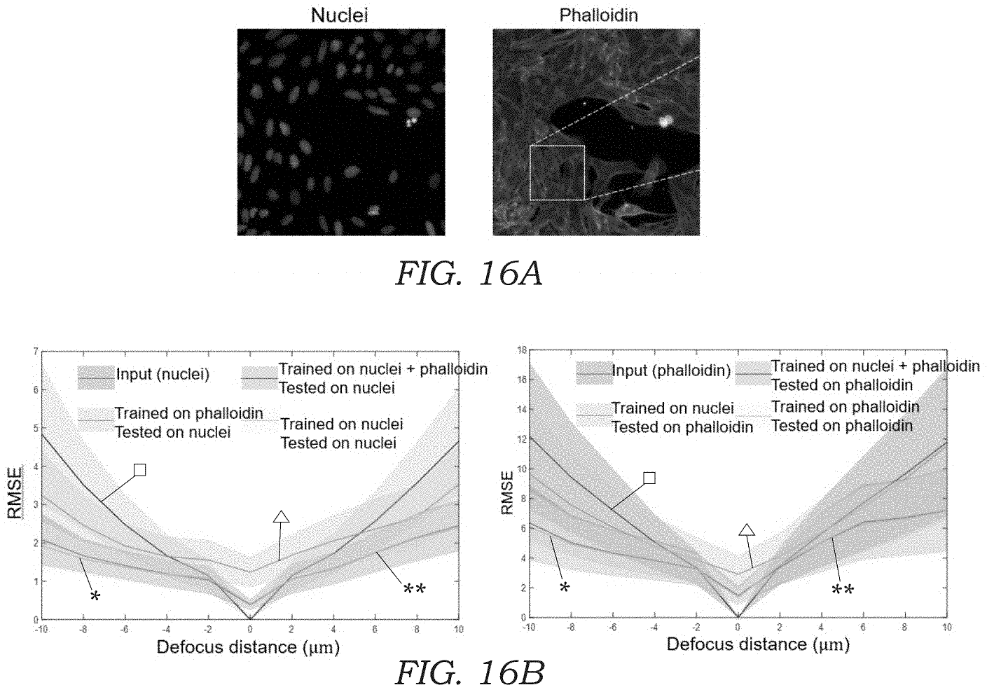

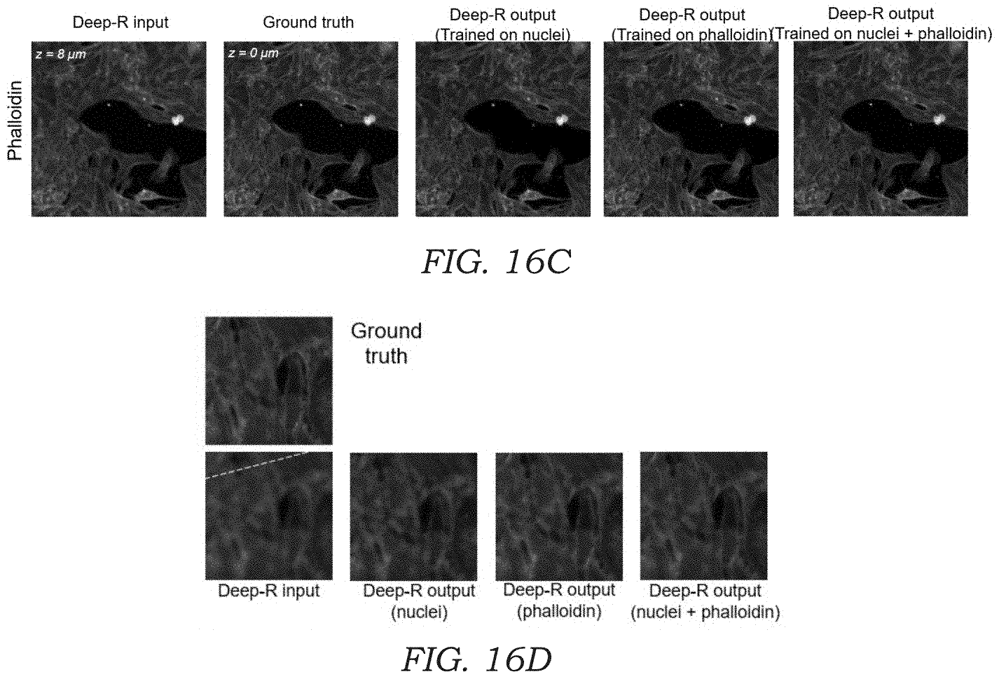

As generalization is still an open challenge in machine learning, the generalization capabilities of the trained neural network 10 in autofocusing images of new sample types that were not present during the training phase was undertaken. For that, the public image dataset BBBC006v1 from the Broad Bioimage Benchmark Collection was used. The dataset was composed of 768 image z-stacks of human U2OS cells, obtained using a 20× objective scanned using ImageXpress Micro automated cellular imaging system (Molecular Devices, Sunnyvale, Calif.). at two different channels for nuclei (Hoechst 33342, Ex/Em 350/461 nm) and phalloidin (Alexa Fluor 594 phalloidin, Ex/Em 581/609 nm), respectively, as shown in FIG. 16A. Three (3) Deep-R networks 10 were separately trained with a defocus range of +10 μm on datasets that contain images of (1) only nuclei, (2) only phalloidin and (3) both nuclei and phalloidin, and tested their performance on images from different types of sample. As expected, the network 10 has its optimal blind inference achieved on the same type of samples that it was trained with (FIG. 16B (* curve)). Training with the mixed sample also generates similar results, with slightly higher RMSE error (FIG. 16B (**curve)). Interestingly, even when tested on images of a different sample type and wavelengths, Deep-R still performs autofocusing over the entire defocus training range (FIG. 16B, A curves). A more concrete example is given in FIGS. 16C and 16D, where the Deep-R network 10 is trained on the simple, sparse nuclei images, and still brings back some details when blindly tested on the densely connected phalloidin images.

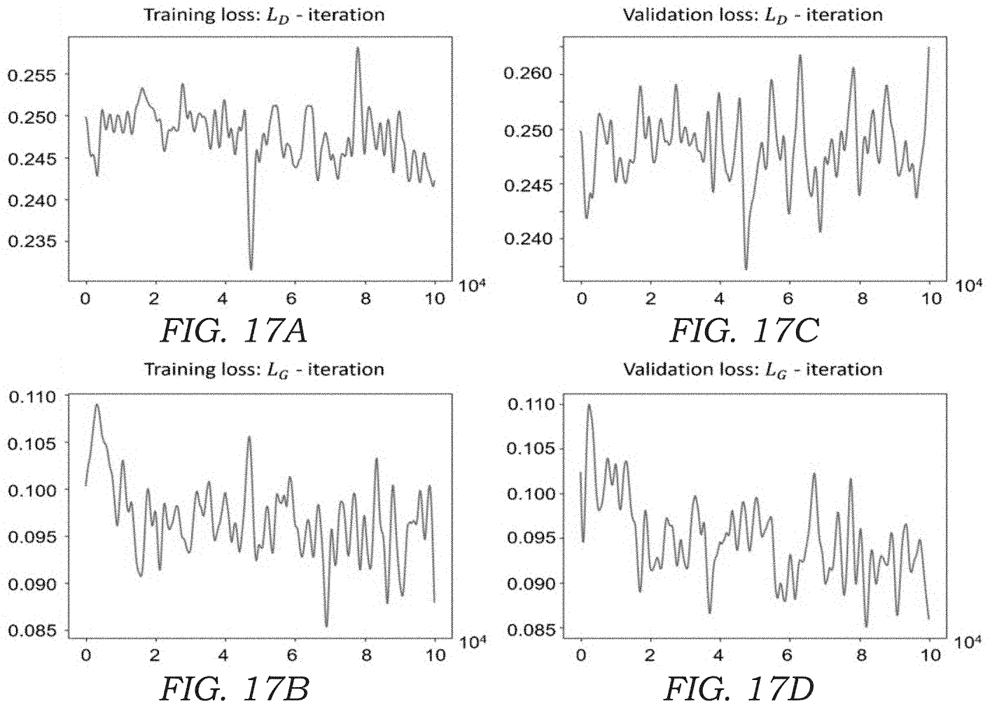

One general concern for the applications of deep learning methods to microscopy is the potential generation of spatial artifacts and hallucinations. There are several strategies that were implemented to mitigate such spatial artifacts in output images 52 generated by the Deep-R network 10. First, the statistics of the training process was closely monitored, by evaluating e.g., the validation loss and other statistical distances of the output data with respect to the ground truth images. As shown in FIGS. 17A-17D, the training loss (FIGS. 17A, 17B) and validation loss curves (FIGS. 17C, 17D) demonstrate that a good balance, as expected, between the generator network 120 and discriminator network 122 was achieved and possible overfitting was avoided. Second, image datasets with sufficient structural variations and diversity were used for training. For example, ˜1000 FOVs were included in the training datasets of each type of sample, covering 100 to 700 mm² of unique sample area (also see Table 2); each FOV contains a stack of defocused images from a large axial range (2 to 10 μm, corresponding to 2.5 to 15 times of the native DOF of the objective lens), all of which provided an input dataset distribution with sufficient complexity as well as an abstract mapping to the output data distribution for the generator to learn from. Third, standard practices in deep learning such as early stopping were applied to prevent overfitting in training Deep-R, as further illustrated in the training curve shown in FIGS. 17A-17D. Finally, it should also be noted that when testing a Deep-R model on a new microscopy system 102 different from the imaging hardware/configuration used in the training, it is generally recommended to either use a form of transfer learning with some new training data acquired using the new microscopy hardware or alternatively train a new model with new samples, from scratch.

TABLE 2

| | | | | Unique | Training | | |
|---|---|---|---|---|---|---|---|
| | Training | Validation | Testing | sample | defocus | z step | |
| | set | set | set | area | range | size | Depths at |
| | (FOV) | (FOV) | (FOV) | (mm²) | (μm) | (μm) | each FOV |
| Flat breast tissue | 1156 | 118 | 6 | 446 | ±5 μm | 0.5 | 21 |
| (20X, DAPI) | | | | | | | |
| Tilted breast tissue | / | / | 18 | 6.3 | / | 0.2 | |
| (20X, DAPI) | | | | | | | |
| Ovary tissue | 874 | 218 | 26 | 97 | ±2 μm, | 0.2 | 21, 51, |
| (40X, Cy5) | | | | | ±5 μm, | | 101 |
| | | | | | ±10 μm | | |
| H&E Stained prostate | 1776 | 205 | 58 | 710 | ±10 μm | 0.5 | 41 |
| (20X, Brightfield) | | | | | | | |
| 300 nm fluorescent | 1077 | 202 | 20 | 113 | ±5 μm, | 0.2 | 51, 81 |
| beads | | | | | ±8 μm | | |
| (40X, Texas Red) | | | | | | | |
| Human U2OS cells | 345 for | 51 for each | 38 for | / | ±10 μm | 2 | 11 |
| (20X, two channels for | each | channel | each | | | | |
| nuclei and phalloidin, | channel | | channel | | | | |
| respectively) | | | | | | | |

Deep-R is a deep learning-based autofocusing framework that enables offline, blind autofocusing from a single microscopy image 50. Although trained with uniformly defocused images, Deep-R can successfully autofocus images of samples 100 that have non-uniform aberrations, computationally extending the DOF of the microscopic imaging system 102. This method is widely applicable to various incoherent imaging modalities e.g., fluorescence microscopy, brightfield microscopy and darkfield microscopy, where the inverse autofocusing solution can be efficiently learned by a deep neural network through image data. This approach significantly increases the overall imaging speed, and would especially be important for high-throughput imaging of large sample areas over extended periods of time, making it feasible to use out-of-focus images without the need for re-imaging the sample, also reducing the overall photon dose on the sample.

Materials and Methods

Sample Preparation

Breast, ovarian and prostate tissue samples: the samples were obtained from the Translational Pathology Core Laboratory (TPCL) and prepared by the Histology Lab at UCLA. All the samples were obtained after the de-identification of the patient related information and prepared from existing specimens. Therefore, the experiments did not interfere with standard practices of care or sample collection procedures. The human tissue blocks were sectioned using a microtome into 4 μm thick sections, followed by deparaffinization using Xylene and mounting on a standard glass slide using Cytoseal™ (Thermo-Fisher Scientific, Waltham, Mass., USA). The ovarian tissue slides were labelled by pan-cytokeratin tagged by fluorophore Opal 690, and the prostate tissue slides were stained with H&E.

Nano-bead sample preparation: 300 nm fluorescence polystyrene latex beads (with excitation/emission at 538/584 nm) were purchased from MagSphere (PSFR300NM), diluted 3,000× using methanol. The solution is ultrasonicated for 20 min before and after dilution to break down clusters. 2.5 μL of diluted bead solution was pipetted onto a thoroughly cleaned #1 coverslip and let dry.

3D nanobead sample preparation: following a similar procedure as described above, nanobeads were diluted 3,000× using methanol. 10 μL of Prolong Gold Antifade reagent with DAPI (ThermoFisher P-36931) was pipetted onto a thoroughly cleaned glass slide. A droplet of 2.5 μL of diluted bead solution was added to Prolong Gold reagent and mixed thoroughly. Finally, a cleaned coverslip was applied to the slide and let dry.

Image Acquisition

The autofluorescence images of breast tissue sections were obtained by an inverted microscope (IX83, Olympus), controlled by the Micro-Manager microscope automation software. The unstained tissue was excited near the ultraviolet range and imaged using a DAPI filter cube (OSF13-DAPI-5060C, EX377/50, EM447/60, DM409, Semrock). The images were acquired with a 20×/0.75NA objective lens (Olympus UPLSAPO 20×/0.75NA, WD 0.65). At each FOV of the sample, autofocusing was algorithmically performed, and the resulting plane was set as the initial position (i.e., reference point), z=0 μm. The autofocusing was controlled by the OughtaFocus plugin in Micro-Manager, which uses Brent's algorithm for searching of the optimal focus based on Vollath-5 criterion. For the training and validation datasets, the z-stack was taken from −10 μm to 10 μm with 0.5 μm axial spacing (DOF=0.8 μm). For the testing image dataset, the axial spacing was 0.2 μm. Each image was captured with a scientific CMOS image sensor (ORCA-flash4.0 v.2, Hamamatsu Photonics) with an exposure time of ˜100 ms.

The immunofluorescence images of human ovarian samples were imaged on the same platform with a 40×/0.95NA objective lens (Olympus UPLSAPO 40×/0.95NA, WD 0.18), using a Cy5 filter cube (CY5-4040C-OFX, EX628/40, EM692/40, DM660, Semrock). After performing the autofocusing, a z-stack was obtained from −10 μm to 10 μm with 0.2 μm axial steps.

Similarly, the nanobeads sample were imaged with the same 40×/0.95NA objective lens, using a Texas red filter cube (OSFI3-TXRED-4040C, EX562/40, EM624/40, DM593, Semrock), and a z-stack was obtained from −10 μm to 10 μm with 0.2 μm axial steps after the autofocusing step (z=0 μm).

Finally, the H&E stained prostate samples were imaged on the same platform using brightfield mode with a 20×/0.75NA objective lens (Olympus UPLSAPO 20×/0.75NA, WD 0.65). After performing autofocusing on the automation software, a z-stack was obtained from −10 μm to 10 μm with an axial step size of 0.5 μm.

Data Pre-Processing

To correct for rigid shifts and rotations resulting from the microscope stage, the image stacks were first aligned using the ImageJ plugin ‘StackReg’. Then, an extended DOF (EDOF) image was generated using the ImageJ plugin ‘Extended Depth of Field’ for each FOV, which typically took ˜180 s/FOV on a computer with i9-7900X CPU and 64 GB RAM. The stacks and the corresponding EDOF images were cropped into non-overlapping 512×512-pixel image patches in the lateral direction, and the ground truth image was set to be the one with the highest SSIM with respect to the EDOF image. Then, a series of defocused planes, above and below the focused plane, were selected as input images and input-label image pairs were generated for network training (FIG. 2). The image datasets were randomly divided into training and validation datasets with a preset ratio of 0.85:0.15 with no overlap in FOV. Note also that the blind testing dataset was cropped from separate FOVs from different sample slides that did not appear in the training and validation datasets. Training images are augmented 8 times by random flipping and rotations during the training, while the validation dataset was not augmented. Each pair of input and ground truth images were normalized such that they have zero mean and unit variance before they were fed into the corresponding Deep-R network. The total number of FOVs, as well as the number of defocused images at each FOV used for training, validation and blind testing of the networks are summarized in Table 3.

TABLE 3

| | | | | Training | | |
|---|---|---|---|---|---|---|
| | Training | Validation | Testing | defocus | z | Depths |
| | set | set | set | range | stepsize | at each |
| | (FOV) | (FOV) | (FOV) | (μm) | (μm) | FOV |
| Autofluorescence flat | 1156 | 118 | 6 | ±5 | 0.5 | 21 |
| sample (20X) | | | | | | |
| Autofluorescence tilted | / | / | 18 | / | 0.2 | |
| sample (20X) | | | | | | |
| Immunofluorescence | 874 | 218 | 26 | ±2, ±5, ±10 | 0.2 | 21, 51, |
| (40X) | | | | | | 101 |
| Brightfield (20X) | 1776 | 205 | 58 | ±10 | 0.5 | 41 |
| 300 nm Beads (40X) | 1077 | 202 | 20 | ±5, ±8 | 0.2 | 51, 81 |

Network Structure, Training and Validation

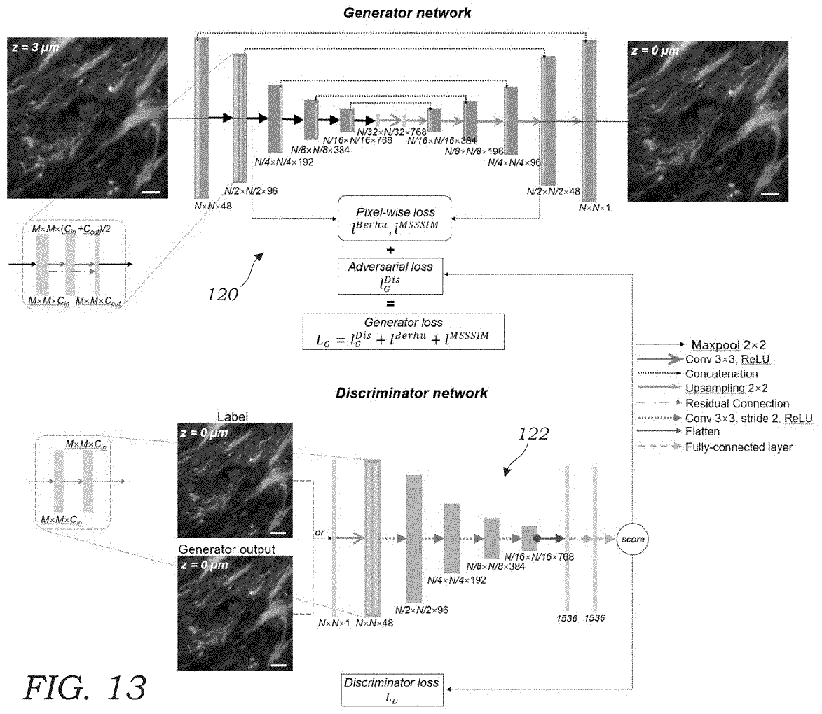

A GAN 10 is used to perform snapshot autofocusing (see FIG. 13). The GAN consists of a generator network 120 and a discriminator network 122. The generator network 120 follows a U-net structure with residual connections, and the discriminator network 122 is a convolutional neural network, following a structure demonstrated, for example, in Rivenson, Y. et al. Virtual histological staining of unlabeled tissue-autofluorescence images via deep learning. Nat. Biomed. Eng. (2019) doi:10.1038/s41551-019-0362-y, which is incorporated herein by reference. During the training phase, the network iteratively minimizes the loss functions of the generator and discriminator networks, defined as:

L_{G}=λ×(1−D(G(x)))²+v×MSSSIM(y,G(x))+ξ×BerHu(y,G(x)) (1)

L_{D}=D(G(x))²+(1−D(y))² (2)

where x represents the defocused input image, y denotes the in-focus image used as ground truth, G(x) denotes the generator output, D(⋅) is the discriminator inference. The generator loss function (L_{G}) is a combination the adversarial loss with two additional regularization terms: the multiscale structural similarity (MSSSIM) index and the reversed Huber loss (BerHu), balanced by regularization parameters λ, ν, ξ. In the training, these parameters are set empirically such that three sub-types of losses contributed approximately equally after the convergence. MSSSIM is defined as:

$$MSSSIM ( x , y ) = {[ \frac{2 {μ}_{{x}_{M}} {μ}_{{y}_{M}} + {C}_{1}}{{μ}_{{x}_{M}}^{2} + {μ}_{{y}_{M}}^{2} + {C}_{1}} ]}^{{α}_{M}} \cdot {\prod }_{j = 1}^{M} {{[ \frac{2 {σ}_{{x}_{j}} {σ}_{{y}_{j}} + {C}_{2}}{{σ}_{{x}_{j}}^{2} + {σ}_{{y}_{j}}^{2} + {C}_{2}} ]}^{{β}_{j}} [ \frac{{σ}_{{x}_{j} {y}_{j}} + {C}_{3}}{{σ}_{x} {σ}_{{y}_{j}} + {C}_{3}} ]}^{{γ}_{j}} ( 3 )$$

where xⱼ and yⱼ are the distorted and reference images downsampled 2^{j-1} times, respectively; μₓ, μ_{y}, are the averages of x, y; σₓ², σ_{y}² are the variances of x, y; σ_{xy} is the covariance of x, y; C₁, C₂, C₃ are constants used to stabilize the division with a small denominator; and α_{M}, βⱼ, γⱼ are exponents used to adjust the relative importance of different components. The MSSSIM function is implemented using the Tensorflow function tf.image.ssim_multiscale, using its default parameter settings. The BerHu loss is defined as:

$$B e r H u ( x , y ) = {{\sum }_{m , n}}_{\vert x ( m , n ) - y ( m , n ) \vert \leq c} \vert x ( m , n ) - y ( m , n ) \vert + {{\sum }_{m , n}}_{\vert x ( m , n ) - y ( m , n ) \vert > c} \frac{{[ x ( m , n ) - y ( m , n ) ]}^{2} + {c}^{2}}{2 c} \qquad ( 4 )$$

where x(m, n) refers to the pixel intensity at point (m, n) of an image of size M×N, c is a hyperparameter, empirically set as ˜10% of the standard deviation of the normalized ground truth image. MSSSIM provides a multi-scale, perceptually-motivated evaluation metric between the generated image and the ground truth image, while BerHu loss penalizes pixel-wise errors, and assigns higher weights to larger losses exceeding a user-defined threshold. In general, the combination of a regional or a global perceptual loss, e.g., SSIM or MSSSIM, with a pixel-wise loss, e.g., L1, L2, Huber and BerHu, can be used as a structural loss to improve the network performance in image restoration related tasks. The introduction of the discriminator helps the network output images to be sharper.

All the weights of the convolutional layers were initialized using a truncated normal distribution (Glorot initializer), while the weights for the fully connected (FC) layers were initialized to 0.1. An adaptive moment estimation (Adam) optimizer was used to update the learnable parameters, with a learning rate of 5×10⁻⁴ for the generator and 1×10⁻⁶ for the discriminator, respectively. In addition, six updates of the generator loss and three updates of the discriminator loss are performed at each iteration to maintain a balance between the two networks. A batch size of five (5) was used in the training phase, and the validation set was tested every 50 iterations. The training process converges after ˜100,000 iterations (equivalent to ˜50 epochs) and the best model is chosen as the one with the smallest BerHu loss on the validation set, which was empirically found to perform better. The details of the training and the evolution of the loss term are presented in FIGS. 17A-17D. For each dataset with a different type of sample and a different imaging system, Deep-R network 10 was trained from scratch.

For the optimization of the DPM decoder 124 (FIG. 14A), the same structure of the up-sampling path of Deep-R network 10 is used, and then optimized using an Adam optimizer with learning rate of 1×10⁻⁴ and an L2-based objective function (L_{Dec}), as expressed below:

L_{Dec}=Σ_{m,n}(x(m,n)−y(m,n))² (5)

where x and y denote the output DPM and the ground-truth DPM, respectively, and m, n stand for the lateral coordinates.

Implementation Details

The network is implemented using TensorFlow on a PC with Intel Xeon Core W-2195 CPU at 2.3 GHz and 256 GB RAM, using Nvidia GeForce RTX 2080Ti GPU. The training phase using ˜30,000 image pairs (512×512 pixels in each image) takes about ˜30 hours. After the training, the blind inference (autofocusing) process on a 512×512-pixel input image takes ˜0.1 sec.

Image Quality Analysis

Difference image calculation: the raw inputs and the network outputs were originally 16-bit. For demonstration, all the inputs, outputs and ground truth images were normalized to the same scale. The absolute difference images of the input and output with respect to the ground truth were normalized to another scale such that the maximum error was 255.

Image sharpness coefficient for tilted sample images: Since there was no ground truth for the tilted samples, a reference image was synthesized using a maximum intensity projection (MIP) along the axial direction, incorporating 10 planes between z=0 μm and z=1.8 μm for the best visual sharpness. Following this, the input and output images were first convolved with a Sobel operator to calculate a sharpness map, S, defined as:

S(I)=\sqrt{I_{X}²+I_{Y}²} (6)

where I_{X}, I_{Y} represent the gradients of the image I along X and Y axis, respectively. The relative sharpness of each row with respect to the reference image was calculated as the ordinary least square (OLS) coefficient without intercept:

$${\hat{α}}_{i} = \frac{{S ( x )}_{i} {S ( y )}_{i}^{T}}{{S ( y )}_{i} {S ( y )}_{i}^{T}} , i = 1 , 2 , … , N \qquad ( 7 )$$

where Sᵢ is the i-th row of S, y is the reference image, N is the total number of rows.

The standard deviation of the relative sharpness is calculated as:

$$Std ( {\hat{α}}_{i} ) = \sqrt{\frac{{RSS}_{i}}{( N - 1 ) \cdot {S ( y )}_{i} . {S ( y )}_{i}^{T} .}} , {RSS}_{i} = \sum {( {S ( x )}_{i} - {\hat{α}}_{i} {S ( y )}_{i} )}^{2} \qquad ( 8 )$$

where RSSᵢ stands for the sum of squared residuals of OLS regression at the i^{th} row.

Estimation of the Lateral FWHM Values for PSF Analysis

A threshold was applied to the most focused plane (with the largest image standard deviation) within an acquired axial image stack to extract the connected components. Individual regions of 30×30 pixels were cropped around the centroid of the sub-regions. A 2D Gaussian fit (lsqcurvefit) using Matlab (MathWorks) was performed on each plane in each of the regions to retrieve the evolution of the lateral FWHM, which was calculated as the mean FWHM of x and y directions. For each of the sub-regions, the fitted centroid at the most focused plane was used to crop a x-z slice, and another 2D Gaussian fit was performed on the slide to estimate the axial FHWM. Using the statistics of the input lateral and axial FWHM at the focused plane, a threshold was performed on the sub-regions to exclude any dirt and bead clusters from this PSF analysis.

Implementation of RL and Landweber Image Deconvolution Algorithms

The image deconvolution (which was used to compare the performance of Deep-R) was performed using the ImageJ plugin DeconvolutionLab2. The parameters for RL and Landweber algorithm were adjusted such that the reconstructed images had the best visual quality. For Landwerber deconvolution, 100 iterations were used with a gradient descent step size of 0.1. For RL deconvolution, the best image was obtained at the 100^{th} iteration. Since the deconvolution results exhibit known boundary artifacts at the edges, 10 pixels at each image edge were cropped when calculating the SSIM and RMSE index to provide a fair comparison against Deep-R results.

Speed Measurement of Online Autofocusing Algorithms

The autofocusing speed measurement is performed using the same microscope (IX83, Olympus) with a 20×/0.75NA objective lens using nanobead samples. The online algorithmic autofocusing procedure is controlled by the OughtaFocus plugin in Micro-Manager, which uses the Brent's algorithm. The following search parameters were chosen: SearchRange=10 μm, tolerance=0.1 μm, exposure=100 ms. Then, the autofocusing time of 4 different focusing criteria were compared: Vollath-4 (VOL4), Vollath-5 (VOL5), standard deviation (STD) and normalized variance (NVAR). These criteria are defined as follows:

$${F}_{VOL4} = {\sum }_{m = 1}^{M - 1} {\sum }_{n = 1}^{N} x ( m , n ) x ( m + 1 , n ) - {\sum }_{m = 1}^{M - 2} {\sum }_{n = 1}^{N} x ( m , n ) x ( m + 2 , n ) \qquad ( 9 )$$

$${F}_{VOL5} = {\sum }_{m = 1}^{M - 1} {\sum }_{n = 1}^{N} x ( m , n ) x ( m + 1 , n ) - MN {μ}^{2} \qquad ( 10 )$$

$${F}_{STD} = \sqrt{\frac{1}{MN} {\sum }_{m = 1}^{M} {\sum }_{n = 1}^{N} {[ x ( m , n ) - μ ]}^{2}} \qquad ( 11 )$$

$${F}_{N V A R} = \frac{1}{M N μ} {\sum }_{m = 1}^{M} {\sum }_{n = 1}^{N} {[ x ( m , n ) - μ ]}^{2} \qquad ( 12 )$$

where μ is the mean intensity defined as:

$$μ = {\sum }_{m = 1}^{M} {\sum }_{n = 1}^{N} x ( m , n ) \qquad ( 13 )$$

The autofocusing time is measured by the controller software, and the exposure time for the final image capture is excluded from this measurement. The measurement is performed on four (4) different FOVs, each measured four (4) times, with the starting plane randomly initiated from different heights. The final statistical analysis (Table 1) was performed based on these 16 measurements.

While embodiments of the present invention have been shown and described, various modifications may be made without departing from the scope of the present invention. For example, the system and method described herein may be used to autofocus a wide variety of spatially non-uniform defocused images including spatially aberrated images. Likewise, the sample or specimen that is imaged can be autofocused with a single shot even though the sample holder is tilted, curved, spherical, or spatially warped. The invention, therefore, should not be limited, except to the following claims, and their equivalents.

1. A method of autofocusing a defocused microscope image of a sample or specimen comprising:
providing a trained deep neural network that is executed by software using one or more processors, the trained deep neural network comprising a generative adversarial network (GAN) framework trained using a plurality of matched pairs of (1) defocused microscopy images, and (2) corresponding ground truth focused microscopy images;
inputting a defocused microscopy input image of the sample or specimen to the trained deep neural network; and
outputting a focused output image of the sample or specimen from the trained deep neural network that corresponds to the defocused microscopy input image.

2. The method of claim 1, wherein a plurality of defocused microscopy images of the sample or specimen are input to the trained deep neural network wherein the plurality of defocused microscopy images are obtained above and/or below a focal plane of corresponding ground truth focused microscopy images.

3. The method of claim 1, wherein the GAN framework is trained by minimizing a loss function of a generator network and discriminator network wherein the loss function of the generator network comprises at least one of adversarial loss, a multiscale structural similarity (MSSSIM) index, structural similarity (SSIM) index, and/or a reversed Huber loss (BerHu).

4. The method of claim 1, wherein the microscope comprises one of a fluorescence microscope, a brightfield microscope, a super-resolution microscope, a confocal microscope, a light-sheet microscope, a darkfield microscope, a structured illumination microscope, a total internal reflection microscope, or a phase contrast microscope.

5. The method of claim 1, wherein the trained deep neural network outputs a focused image of the sample or specimen or a field-of-view (FOV) using at least one processor comprising a central processing unit (CPU) and/or a graphics processing unit (GPU).

6. The method of claim 1, wherein the defocused microscopy input image comprises a tilted image.

7. The method of claim 1, wherein the defocused microscopy input image comprises a spatially uniform or non-uniform defocused image.

8. The method of claim 1, wherein the defocused microscopy input image is spatially aberrated.

9. A system for outputting autofocused microscopy images of a sample or specimen comprising a computing device having image processing software executed thereon, the image processing software comprising a trained deep neural network that is executed using one or more processors of the computing device, wherein the trained deep neural network comprises a generative adversarial network (GAN) framework trained using a plurality of matched pairs of (1) defocused microscopy images, and (2) corresponding ground truth focused microscopy images, the image processing software configured to receive a defocused microscopy input image of the sample or specimen and outputting a focused output image of the sample or specimen from the trained deep neural network that corresponds to the defocused microscopy input image.

10. The system of claim 9, further comprising a microscope that captures a defocused microscopy image of the sample or specimen to be used as the input image to the trained deep neural network.

11. The system of claim 10, wherein the microscope comprises one of a fluorescence microscope, a brightfield microscope, a super-resolution microscope, a confocal microscope, a light-sheet microscope, a darkfield microscope, a structured illumination microscope, a total internal reflection microscope, or a phase contrast microscope.

12. The system of claim 9, wherein the computing device comprises at least one of a: personal computer, laptop, tablet, server, ASIC, or one or more graphics processing units (GPUs), and/or one or more central processing units (CPUs).

13. The system of claim 10, wherein the trained deep neural network extends the depth of field of the microscope used to acquire the input image to the trained neural network.

14. The system of 9, wherein the sample or specimen is contained on a sample holder that is tilted, curved, spherical, or spatially warped.

15. The system of claim 9, wherein the defocused microscopy image comprises a spatially uniform or non-uniform defocused image.

16. The system of claim 9, further comprising a whole slide scanning microscope that obtains a plurality of images of the tissue sample or specimen, wherein at least some of the plurality of images are defocused microscopy images of the sample or specimen to be used as the input images to the trained deep neural network.
